(19) United States
(12) Patent Application Publication
(10) Pub. No.: US 2018/0173730 A1
(43) Pub. Date: Jun. 21, 2018

(54) Generating a Database with Mapped Data

(71) Applicant: Clinigence, LLC, Atlanta, GA (US)

(72) Inventors: Mark Copenhaver, Johns Creek, GA (US); Charles Kandzierski, Chamblee, GA (US); Jacob Zohar Margolin, Atlanta, GA (US); Beth Copenhaver, Johns Creek, GA (US)

(21) Appl. No.: 15/882,688

(22) Filed: Jan. 29, 2018

Related U.S. Application Data
(63) Continuation-in-part of application No. 13/710,247, filed on Dec. 10, 2012, now abandoned.
(60) Provisional application No. 61/706,919, filed on Sep. 28, 2012.

(51) Int. Cl. G06F 17/30; G06N 99/00

(52) U.S. Cl. CPC G06F 17/30294; G06F 17/30477; G06N 99/005; G06F 17/30569; G06F 17/30958; G06F 17/30554

(57) ABSTRACT

Systems and methods for generating a database that reduces storage space and improves data retrieval time are disclosed. Provider data is received from a data source, where the provider data includes objects. Profile data is generated from the provider data that organizes the objects into classes and links the classes based on properties of the objects. A source terminology that includes source terms that are used to describe the objects is determined. Each source term in the source terminology is mapped to a corresponding authoritative term in an authoritative terminology. A database is generated that includes the provider data, the profile data, and the mapping of each source term to the corresponding authoritative term.

### BACKGROUND

The specification relates to data management. In particular, the specification relates to generating a database with mapped data.

The generation of a database is a difficult process when the database is created from data that originates from different data providers and the data fields use inconsistent terminology. For example, a first data source provides a first data file with data fields A₁, B₁, and C₁; a second data source provides a second data file with data fields A₂, B₂, and C₂; and a third data source provides a third data file with data fields A₃, B₃, and C₃. The three data files may use data fields that include the same concepts of A, B, and C, but if the data files use different terms for each of the data fields, a system may generate a larger and confusing database from the different data sources that treats each of the terms as unique fields. As a result, the resulting database occupies a large amount of computer memory.

This problem becomes even more compounded when the data files are complicated. In addition to the previous attempts to combine the data files taking up too much space in the computer memory, this problem results in a slower processing of database queries because the database includes so many data items. As a result, there exists a need for a system that generates a database from multiple data files that reduces a data storage size and that reduces processing time during data retrieval as compared to previous attempts to generate databases from multiple data source providers.

### SUMMARY

According to one innovative aspect of the subject matter described in this disclosure, a method includes receiving provider data from a data source server, wherein the provider data includes objects. The method further includes generating profile data from the provider data that organizes the objects into classes and links the classes based on properties of the objects. The method further includes determining, from the provider data, a source terminology that includes source terms that are used to describe the objects. The method further includes mapping each source term in the source terminology to a corresponding authoritative term in an authoritative terminology based on a crowd source mapping, wherein the crowd source mapping performs the mapping responsive to a credibility number threshold or a credibility percentage threshold being satisfied. The method further includes generating a database that includes the provider data, the profile data, and the mapping of each source term to the corresponding authoritative term.

In some embodiments, the method further includes receiving feedback from a user about the mapping and revising the mapping based on the feedback, wherein the mapping and revising the mapping are based on machine learning. In some embodiments, the method further includes receiving a query that includes search terms for data files that correspond to the search terms, retrieving search results that correspond to the data files from the database, and generating a report that includes the search results. In some embodiments, the method further includes applying a classification structure to profile data by starting at a root partition and, responsive to the profile data satisfying criteria of a root class, descending to the root class, responsive to the profile data satisfying criteria of a child class, descending to the child class, and continuing to descend until the profile data arrives at a final class in the classification structure. In some embodiments, the credibility number threshold is satisfied if a number of data source providers from a set of data source providers map the source term to a same authoritative term as the corresponding authoritative term exceeds the credibility number threshold and the credibility percentage threshold is satisfied if a percentage of the data source providers from the set of data source providers map the source term to the same authoritative term as the corresponding authoritative term exceeds the credibility percentage threshold. In some embodiments, the method further includes receiving rule data describing a declarative classification rule from a client device, wherein the declarative classification rule defines one or more partitions in a classification structure. In some embodiments, each object has an object class and a mood and wherein the mood indicates one of an act that has happened, a request for an act to happen, a goal, and a criterion. In some embodiments, the method further includes storing the profile data as a graph comprising nodes, wherein each node represents one of the classes that applies to a patient. In some embodiments, the method further includes updating the profile data to describe the objects using the authoritative terminology and updating the database to include updated profile data.

The specification describes numerous advantages. First, system and methods transform provider data into profile data that is stored in a database. Second, the database is a specific type of data structure designed to improve the way a computer stores and retrieves data in memory. Third, retrieval calls for data files from the database take less processing time, resulting in a more efficient special-purpose computer. Fourth, the specification describes machine learning that receives feedback and uses the feedback to improve the functioning of the database.

### BRIEF DESCRIPTION OF THE DRAWINGS

FIG. 1 is a high-level block diagram illustrating a system for managing provider data according to some embodiments.

FIG. 2 is a block diagram illustrating a data management application according to some embodiments.

FIG. 3 is a flowchart illustrating a method for managing provider data according to some embodiments.

FIGS. 4A and 4B are flowcharts illustrating another method for managing provider data according to some embodiments.

FIG. 5 is a flowchart illustrating a method for receiving one or more declarations according to some embodiments.

FIG. 6 is a graphic representation illustrating an example user interface for receiving a declaration according to some embodiments.

FIG. 7 is a graphic representation illustrating example provider data that is transformed into profile data based on a semantic web model according to some embodiments.

FIG. 8A is a graphic representation illustrating a classifications structure starting at a root partition according to some embodiments.

FIG. 8B is a graphic representation illustrating a classification structure at a root class according to some embodiments.

FIG. 8C is a graphic representation illustrating an example classification process applied in a classification structure according to some embodiments.

FIG. 9 is a graphic representation illustrating example profile data that was transformed from provider data based on a semantic web model according to some embodiments.

FIG. 10 is a graphic representation illustrating an example classification structure according to some embodiments.

FIG. 11 is a graphic representation illustrating an example mapping according to some embodiments.

FIGS. 12A-12C are graphic representations illustrating example user interfaces that include information about the mapping used to create the database according to some embodiments.

FIG. 13 is a graphic representation illustrating an example program according to some embodiments.

FIG. 14 is a flowchart illustrating a method for generating a database according to some embodiments.

### DETAILED DESCRIPTION

### System Overview

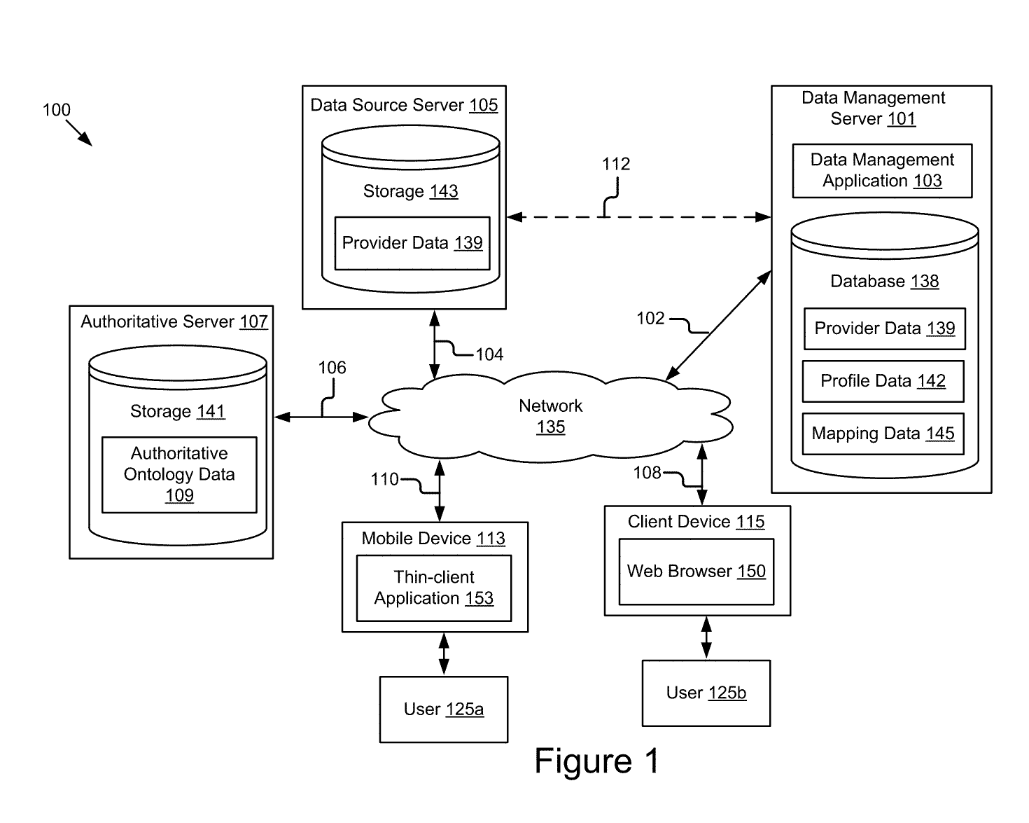

FIG. 1 is a high-level block diagram illustrating a system 100 for managing provider data according to some embodiments. In the illustrated embodiment, the system 100 includes a data management server 101, a data source server 105, an authoritative server 107, a mobile device 113, and a client device 11. Although only one data management server 101, one data source server 105, one authoritative server 107, one mobile device 113, and one client device 115 are illustrated in FIG. 1, the system may include any number of data management servers 101, data source servers 105, authoritative servers 107, mobile devices 113, and client devices 115.

In the illustrated embodiment, the entities of the system 100 are communicatively coupled by a network 135. The data management server 101 is communicatively coupled to the network 135 via signal line 102. The data source server 105 is communicatively coupled to the network 135 via signal line 104. The authoritative server 107 is communicatively coupled to the network 135 via signal line 106. The client device 115 is communicatively coupled to the network 135 via signal line 108. The mobile device 113 is communicatively coupled to the network 135 via signal line 110. The data source server 105 may be directly coupled to the database management server 101 via signal line 112. Signal line 112 is depicted using a dashed line to indicate that it is an optional feature of the system 100.

The data source server 105 is a hardware server that includes a processor, a memory, and network communication capabilities. The data source server 105 sends and receives data to and from other entities of the system 100 via the network 135. For example, the data source server 105 provides provider data 139 to the data management application 103. In some embodiments, the data source server 105 is operated by a data source provider. The provider submits provider data 139 to the data source server 105, which sends the provider data 139 to the data management application 103.

The data source server 105 includes storage 143. The storage 143 is a non-transitory memory that stores data. For example, the storage 143 is a dynamic random access memory device (DRAM) device, a static random access memory (SRAM) device, flash memory, or some other memory device. In some embodiments, the storage 143 includes a non-volatile memory or similar permanent storage device and media, such as a hard disk driver, a compact disc read only memory (CD-ROM) device, a digital versatile disc read only memory (DVD-ROM), a DVD-random access memory (DVD-RAM) device, a DVD-rewritable (DVD-RW) device, a flash memory device, or some other non-volatile storage device.

In the illustrated embodiment, the storage device 143 stores provider data 139. The provider data 139 is any data generated by a data source server 105. For example, the provider data 139 may be clinical data that describes a set of medical records. For example, the clinical data includes data describing assertions describing events associated with patients. Each assertion includes, for example, a timestamp and a description of who owns the assertion, who recorded the assertions, and/or who ordered the assertion. Examples of events that are described by assertions include, but are not limited to, office visits, medical decisions (e.g., diagnoses, progress notes, etc.), observations (vitals, physical examinations, lab results, etc.), procedures performed on patients, medical treatments and cost, medications prescribed for patients and/or any other data that can appear in medical records. The clinical data may be particular to a patient and referred to as an electronic health record.

In some embodiments, the data source server 105 represents multiple data source servers 105 that include different types of provider data 139. For example, the provider data 139 may be clinical data, such as electronic health records, and the data source servers 105 may include a medical practice, a hospital, medical storage, and payers, such as insurance providers. Each data source server 105 may generate provider data 139 with the same type of data describing using different data fields. For example, a first data source server 105 may include provider data 139 that describes gender as being either male or female and a second data source server 105 may include provider data 139 that describes sex as being M or F. The provider data 139 in both cases includes the same concepts but traditional data organizing methodologies would generate a database with gender and sex instead of mapping the source terms to authoritative terms to obtain a smaller and more efficient database.

The authoritative server 107 is a hardware server that includes a processor, a memory, and network communication capabilities. The authoritative server 107 sends and receives data to and from other entities of the system 100 via the network 135. For example, the authoritative server 107 provides data describing terminology used in an authoritative ontology to the data management application 103. In the illustrated embodiment, the authoritative server 107 includes a storage device. The storage 141 is a non-transitory memory that stores data. The storage 141 has similar structure and provides similar functionality as those describes above for the storage 143, and the description will not be repeated here.

In the illustrated embodiment, the storage 141 stores authoritative ontology data 109. The authoritative ontology data 109 is data describing one or more authoritative ontologies. For example, the authoritative ontology data 109 includes data describing terminology used in an authoritative ontology. Examples of an authoritative ontology include, but are not limited to, the International Classification of Diseases 9^{th} revision (ICD-9), the International Classification of Diseases 10^{th} revision (ICD-10), the International Classification of Diseases 11^{th} revision (ICD-11), Rx-Norm, Current Procedural Terminology (CPT), Logical Observation Identifiers Names and Codes (LOINC), Cactus Virus X (CVX), Healthcare Common Procedure Coding Systems (HCPCS), Health Level 7 (HL7), Systematized Nomenclature of Medicine (Snomed), Payer, etc.

The data manager server 101 is a hardware server that includes a processor, a memory, and network communication capabilities. The data management server 101 transmits and receives data to and from other entities of the system 100 via the network 135. In the illustrated embodiment, the data management server 101 includes a data management application 103 and a database 138.

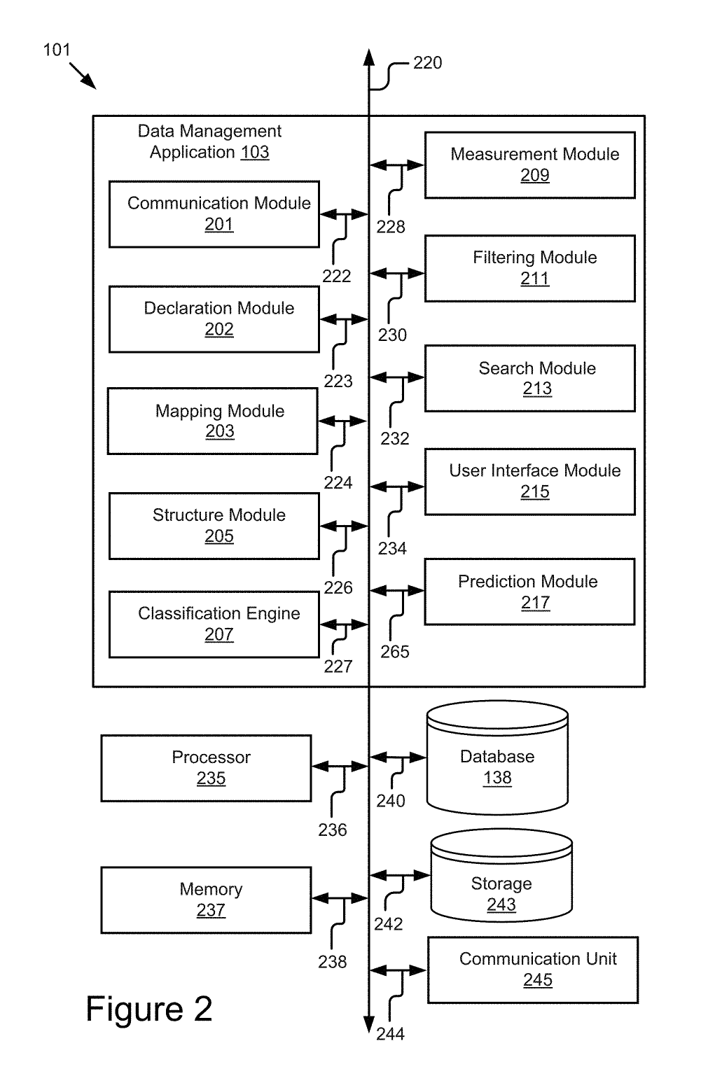

The data management application 103 can be code and routines for transforming provider data 139 into profile data 142. In some embodiments, the data management application 103 is implemented using hardware including a field-programmable gate array (FPGA) or an application-specific integrated circuit (ASIC). In some embodiments, the data management application 103 is stored in a combination of devices and server, such as the data manager server 101, the mobile device 113, and the client device 115. The data management application 103 is described below in more detail with reference to FIG. 2.

The database 138 is a non-transitory memory that stores organized data. In some embodiments, the database 138 is a relational database that stores data that is organized based on relationships between the data items. In some embodiments, each data item is classified as a particular instance of a relation and each set of relations is stored in a distinct table. The relational database may be managed by a relational database management system (RDBM) that uses a structured query language (SQL) to process user queries and retrieve search results.

The database 138 may include provider data 139, profile data 142, authoritative ontology data 109, and mapping data 145. The provider data 139 may be received from the data source server 105. The authoritative ontology data 109 may be received from the authoritative server 107. The data management application 103 may use the authoritative ontology data 109 to generate profile data 142 from the provider data 139. The data management application 103 may generate a mapping between the provider data 139 and the profile data 142 that is stored as mapping data 145.

The profile data 142 may be data that is organized from provider data 139 that originated from multiple data source servers 105. The profile data 142 is organized so that redundant source terms are mapped to the same authoritative term. For example, the data management application 103 maps the source terms gender and sex to the authoritative term gender.

The mobile device 113 can be a computer device that includes a memory and a processor. For example, the mobile device 113 can be a laptop computer, a tablet computer, a mobile telephone, a personal digital assistant (PDA), a mobile email device, or another mobile electronic device capable of accessing a network 135. In some embodiments, the mobile device 113 includes a thin-client application 153 for accessing services provided by other servers or devices in the system 100. For example, the thin-client application 153 includes code and routines for accessing the data management application 103.

The mobile device 113 may be used by a user 125a to access the profile data 142. For example, the mobile device 113 may be used by a physician to review and analyze the profile data 142. The physician may generate a search query that the thin-client application 153 transmits to the data management application 103 so that the data management application 103 can query the database 138 for search results. The data management application 103 may transmit the search results to the mobile device 113 for display. In some embodiments, the search results may be a report generated by the data management application 103.

In another example, the mobile device 113 may be used by a patient to review profile data 142 that corresponds to the patient. For example, the profile data 142 may include the electronic health records for the patient that are organized based on the mapping performed by the data management application 103.

The client device 115 can be a stationary computing device that includes a memory and a processor, for example, a desktop computer or another electronic device that is stationary and capable of accessing a network 135. In the illustrated implementation, a user 125b interacts with the client device 115 via a web browser 150. The web browser 150 may display information stored in the database 138 of the data management server 101. For example, the user 125b may request a report that the data management server 101 configures for display on the web browser 150.

The network 135 is a conventional type, wired or wireless, and may have numerous different configurations including a star configuration, token ring configuration, or other configurations. Furthermore, the network 135 may include a local area network (LAN), a wide area network (WAN), and/or other interconnected data paths across which multiple devices may communicate. In some embodiments, the network 135 may be a peer-to-peer network. The network 135 may also be coupled to or include portions of a telecommunications network for sending data in a variety of different communication protocols. In some embodiments, the network 135 includes Bluetooth communication networks or a cellular communications network for sending and receiving data including via short messaging server (SMS), multimedia messaging server (MMS), hypertext transfer protocol (HTTP), direct data connection, wireless application protocol (WAP), email, etc.

### Data Management Application

Referring now to FIG. 2, an example of the data management application 103 is shown in more detail. FIG. 2 is a block diagram illustrating a data management server 101 that includes a data management application 103, a processor 235, a memory 237, a database 138, a storage 243, and a communication unit 245 according to some embodiments. Although FIG. 2 is illustrated as being the data management server 101, in some embodiments some of the components of the data management application 103 may be stored on other devices, such as a mobile device 113 or a client device 115. For example, the mobile device 113 may include a user interface module 215 for displaying a report generated by other components of the data management application 103.

The components of the data management server 101 are communicatively coupled to each other via a bus 220. For example, the processor 235 is communicatively coupled to the bus 220 via signal line 236. The memory 237 is communicatively coupled to the bus 220 via signal line 238. The database 138 is communicatively coupled to the bus 220 via signal line 240. The storage 243 is communicatively coupled to the bus 220 via signal line 244.

The processor 235 comprises an arithmetic logic unit, a microprocessor, a general purpose controller or some other processor array to perform computations, retrieve data stored in the database 138, and/or the storage 243, etc. The processor 235 processes data signals and may comprise various computing architectures including a complex instruction set computer (CISC) architecture, a reduced instruction set computer (RISC) architecture, or an architecture implementing a combination of instruction sets. Although only a single processor 235 is shown in FIG. 2, multiple processors 235 may be included.

The memory 237 stores instructions and/or data that may be executed by the processor 235. The instructions and/or data may comprise code for performing any of the techniques described herein. The memory 237 may be a DRAM device, a SRAM device, flash memory, or some other memory device known in the art. In one embodiment, the memory 237 also includes a non-volatile memory or similar permanent storage device and media such as a hard disk drive, a CD-ROM device, a DVD-ROM device, a DVD-RAM device, a DVD-RW device, a flash memory device, or some other mass storage device known in the art for storing information on a more permanent basis.

The database 138 is a non-transitory memory that stores the provider data 139, the profile data 142, and the mapping data 145. The provider data 139 includes data that describes objects (e.g., assertions, events, etc.) associated with patient. In some embodiments, the database 138 stores a combination of assertions describing data elements in different times such as a series of events that happened to a patient in chronological order. In some embodiments, the database 138 stores profile data 142 that is based on a mapping of the provider data 139 based on an authoritative ontology. In some embodiments, the database 138 includes mapping data 145 that maps the provider data 139 to the profile data 142 based on a semantic web model. In some embodiments, the database 138 stores any other data for providing the functionality described herein.

The storage 243 is a non-transitory memory that stores data. The storage 243 has similar structures and provides similar functionality as those described above for the storage 143, and the descriptions will not be repeated here. In some embodiments, the storage 243 stores one or more of: declaration data describing one or more declarations from data providers (e.g., doctors, nurses, or other specialists); rule data describing one or more declarative classification rules; model data describing a semantic web model; structure data describing one or more classification structures; partition data describing one or more partitions in a classification structure; class data describing one or more classes in a partition; measurement data describing one or more measurement results from a classification structure; data describing filtering parameters; and report data describing one or more reports. Examples of the various types of data stores in the storage 243 are describes below in more detail. The storage 243 may also store any other data for providing the functionality described herein.

The communication unit 245 transmits and receives data to and from one or more of the data source server 105, the authoritative server 107, the mobile device 113, and the client device 115. In some embodiments, the communication unit 245 includes a port for direct physical connection to the network 135 or to another communication channel. For example, the communication unit 245 includes a universal serial bus (USB), category 5 cable (CAT-5), or similar port for wired communication with the network 135. In another embodiment, the communication unit 245 includes a wireless transceiver for exchanging data with the network 135, or with another communication channel, using one or more wireless communication methods, such as IEEE 802.11, IEEE 802.16, Bluetooth®, near field communication (NFC), or another suitable wireless communication method.

In some embodiments, the communication unit 245 includes a cellular communications transceiver for sending and receiving data over a cellular communications network including via SMS, MMS, HTTP, direct data connection, WAP, email, or another suitable type of electronic communication. In some embodiments, the communication unit 245 also provides other conventional connections to the network 135 for distribution of files and/or media objects using standard network protocols including TCP/IP, HTTP, HTTPS, SMTP, etc.

In the illustrated embodiment, the data management application 103 includes a communication module 201, a declaration module 202, a mapping module 203, a structure module 205, a classification engine 207, a measurement module 209, a filtering module 211, a search module 213, a user interface module 215, and a machine learning module 217. The components of the data management application 103 are communicatively coupled to each other via the bus 220.

The communication module 201 includes code and routines that, when executed by the processor, handle communications between components of the data management application 103 and other components of the system 100 of FIG. 1. The communication module 201 is communicatively coupled to the bus 220 via signal line 222. In one embodiment, the communication module 201 receives provider data 139 from the data source server 105 via the communication unit 245 and sends the provider data 139 to the mapping module 203. In another embodiment, the communication module 201 receives rule data describing a declarative classification rule from the mobile device 113 or the client device 115 inputted by a specialist (e.g., a medical service provider such as a doctor or a nurse), and transmits the rule data to the structure module 205. In yet another embodiment, the communication module 201 receives graphical data for depicting a report in a user interface from the user interface module 215 and sends the graphical data to the mobile device 113 and/or the client device 115, causing the mobile device 113 and/or the client device 115 to present the report to a patient via the user interface.

In some embodiments, the communication module 201 also handles communications among the components of the data management application 103. For example, the communication module 201 receives profile data 142 that is organized in a semantic web model from the mapping module 203 and sends the profile data 142 to the classification engine 207. The semantic web model is described below in more detail.

In some embodiments, the communication module 201 retrieves data from the storage 243 and/or the database 138, and sends the retrieved data to components of the data management application 103. For example, the communication module 201 retrieves report data describing a report from the storage 243 and sends the report data to the user interface module 215. In another embodiment, the communication module 201 receives data from components of the data management application 103 and stores the data in the storage 243 and/or the database 138. For example, the mapping module 203 may generate profile data 142 from the provider data 139. The communication module 201 may receive the profile data 142 from the mapping module 203 and store the profile data 142 in the database 138. In other embodiments, the communication module 201 may provide other functionality described herein.

The declaration module 202 is code and routines that, when executed by the processor 235, determines declarative classification rules and/or receives declaration data describing one or more declarations. The declaration module 202 is communicatively coupled to the bus via signal line 223. A declarative classification rule is a rule for classifying provider data 139. In one embodiment, the declarative classification rule describes a class for a portion of the provider data 139. For example, a declarative classification rule includes instructions on how to classify provider data 139 and/or profile data 142 in a classification structure.

In one embodiment, the declarative classification rule includes data defining one or more partitions in a classification structure. For example, a declarative classification rule includes data used to define a partition into three classes: (1) a first class with patients under 18 years old; (2) a second class with patients between 18 years old and 60 years old; and (3) a third class with patients above 60 years old. This example declarative classification rule specifies a rule to classify each patient to one of the three classes in the partition. The partition is described below in more detail.

In some embodiments, the declaration module 202 automatically determines one or more declarative classification rules for the data management system 100 of FIG. 1. In some embodiments, the declaration module 202 instructs the user interface module 215 to generate graphical data for providing a user interface to enable a user, such as a medical service provider (e.g., a doctor, a nurse, etc.), to provide one or more declarative classification rules via the user interface. The declaration module 202 receives the rule data describing the declarative classification rules via the user interface and stores the rule data in the storage 243.

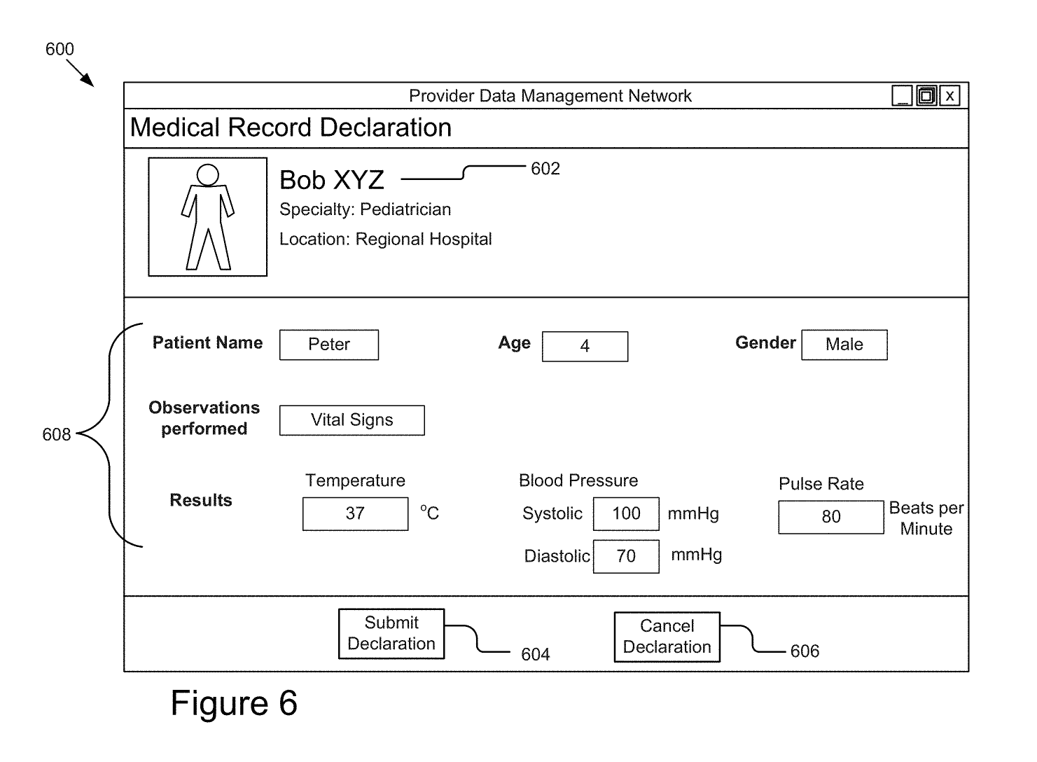

In some embodiments, the declaration module 202 receives, via the communication module 201, a request to report a declaration from a client device 115 or a mobile device 113 operated by a user 125. The declaration module 202 instructs the user interface module 215 to generate graphical data for providing a user interface to the user, enabling the user to input the declaration via the user interface. An example user interface is illustrated in FIG. 6. In some embodiments, the graphical data is generated based on the declarative classification rule. For example, elements of the user interface described by the graphical data can be generated according to the declarative classification rule. The declaration module 202 receives declaration data describing a declaration provided by the user from the client device 115 or the mobile device 113. In some embodiments, the declaration module 202 stores the declaration data in the database 138 and/or the storage 243.

The mapping module 203 includes code and routines that, when executed by the processor 235, generates profile data 142 from provider data 139. The mapping module 203 is communicatively coupled to the bus 200 via signal line 224. In some embodiments, the mapping module 203 receives provider data 139 describing one or more objects (e.g., assertions that describe one or more events) associated with a patient from a data source server 105. The mapping module 203 transforms the provider data 139 into profile data 142 and organizes the profile data 142 into a semantic web model as described below in more detail.

Each object has an object class and optionally a mood. In some embodiments, the mapping module 203 determines an object class and a mood associated with each object. An object class is data indicating a type of act associated with an object. For example, an object class indicates that an object is related to an observation, an encounter, or the administration of a drug. In some embodiments, the object class is modeled using HL7-v3 Act-ClassCode. The object class provides data for defining a role of the object in a medical history of a patient. A mood is data describing a state of an act in an object. For example, a mood indicates whether an act is an intent to perform an event (e.g., a request, an order, a promise, etc.) or an actual occurrence of an event. In another example, a mood indicates one of: an act that has occurred (e.g., a lab test was performed); a request for an act to occur (e.g., a request to perform annual physical examinations); a goal (e.g., a goal to reduce weight to 140 lbs); and a criterion (e.g., if the weight is greater than 140 lbs). In some embodiments, a mood is modeled using HL7-v3 MoodCode.

Each object has one or more intrinsic properties, one or more extrinsic properties, and/or one or more facts. In some embodiments, the mapping module 203 determines one or more intrinsic properties, one or more extrinsic properties, and one or more facts associated with each object. The intrinsic properties, extrinsic properties, and facts are used to classify a patient in a classification structure as described below in more detail.

An intrinsic property is an inherent property of an object. Examples of intrinsic properties include, but are not limited to, one or more timestamps (e.g., a start date, an end date, tec.), a description, and one or more actor relationships (e.g., ordered by, performed by, or supervised by a specialist, such as a doctor, a nurse, etc.). For example, if an object describes a hospitalization event, the intrinsic properties of the object can be a start date, an end date, and a doctor that ordered the hospitalization.

An extrinsic property is an external property of an object. In some embodiments, an extrinsic property includes pertinent data about the object provided by a medical service provider. For example, if an object is a medication order, the extrinsic properties of the object include a drug name, a dosage, a duration for the usage, and other specific instructions. In another example, if an object is a diagnosis, the extrinsic properties include a description of the symptom, a severity, and a location of the symptom.

A fact is an extension of an extrinsic property. In some embodiments, a property (e.g., an extrinsic property) is represented as a name-value pair with the name representing a taxonomy of the property and the value representing a property value. The value is represented using a string with a predetermined length such as forty characters. A fact is generated as an extension to an extrinsic property if one or more of the following conditions are satisfied: (1) a string representing the value of the property exceeds the predetermined length; (2) the property has more than one value (e.g., an ear is both “swollen” and “erythematous”); and (3) the value has associated metadata, such as a unit (e.g., weight=150 lbs).

In some embodiments, the mapping module 203 determines a source ontology used by a data source provider associated with the data source server 105. For example, the mapping module 203 analyzes provider data 139 received from the data source server 105 and determines a source ontology that includes terms, relationships, and words used by the provider. A source ontology is data describing a source terminology that a data source provider uses to describe objects. A data source provider may use source terminology that is different from authoritative terminology; however, the data source provider is likely to be consistent in the usage of its own source terminology. Since different data source providers may use different source terminologies, the mapping module 203 may determine different source ontologies for different data source providers. For example, the mapping module 203 may determine a first source ontology for first source terminology associated with a first data source server 105 and a second source ontology for second source terminology associated with a second data source server 105. A source ontology is also referred to as a non-authoritative ontology herein.

The mapping module 203 generates profile data 142 that is organized as a semantic web model using the objects described by the source ontology. In some embodiments, the mapping module 203 constructs the semantic web model entirely from the source ontology. In some embodiments, the mapping module 203 constructs the source ontology for a data source provider and the semantic web model substantially simultaneously. In some embodiments, the mapping module 203 includes an algorithm that applies a semantic web model to the provider data 139 to organize the provider data 139 to resemble a semantic web. The mapping module 203 may store the profile data 142 in the database 138. In some embodiments, the mapping module 203 stores the semantic web model as a database. For example, the mapping module 203 generates a database that includes the objects from the provider data 139 in columns, where the columns represent classes and links the classes together based on facts and properties.

In some embodiments, the semantic web model organizes: (1) the objects describing a patient and associated ontology terms as classes of a semantic web; and (2) the properties and facts of the objects as links between the classes. In some embodiments, the mapping module 203 generates a database 138, such as a relational database that includes columns in a table for each of the classes and links the columns based on the properties and the facts of the objects. For example, a semantic web model for a blood pressure measurement associated with a patient named Peter is represented as an instance of the following classes: (1) the patient Peter experiences events; (2) a vital signs observation is an event; (3) a blood pressure reading is a measurement of a vital signs observation; (4) systolic is a result of a blood pressure measurement; and (5) diastolic is a result of a blood pressure measurement. In this example, the profile data 142 describing the blood pressure measurement for the patient Peter is a link between ontology terms or a link between the ontology term and the patient.

In some embodiments, the mapping module 203 performs an ontology mapping between a source ontology and one or more authoritative ontologies. For example, the mapping module 203 determines mapping relationships between a source terminology used in a source ontology and one or more authoritative terminologies used in one or more authoritative ontologies.

A source terminology is a terminology used by a data source provider. A source term is a term used in a source terminology. In some embodiments, the mapping module 203 determines the source terminology by extracting source terms from the provider data 139 received from a data source provider.

An authoritative terminology is a terminology used in an authoritative ontology. An authoritative term is a term used in an authoritative terminology. In some embodiments, the mapping module 203 determines the authoritative terms from authoritative ontology data 109 received from an authoritative server 107. For example, the authoritative server 107 may generate a clinical health terminology product called Systematized Nomenclature of Medicine (Snomed) and the authoritative ontology data 109 may include the terminology used by Snomed. The authoritative terms are also referred to as code list items.

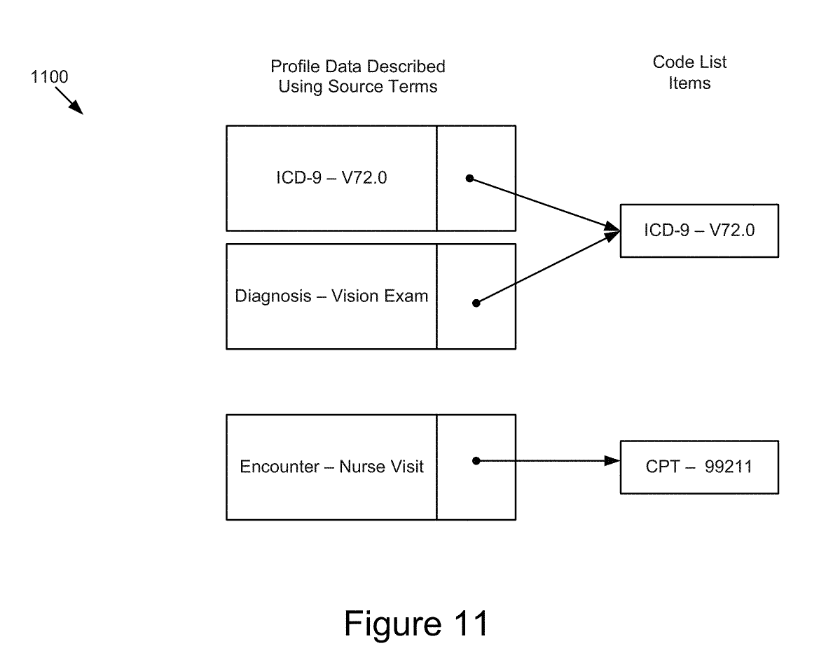

The mapping module 203 maps relationships between a source ontology and one or more authoritative ontologies by mapping one or more source terms in a source terminology to one or more corresponding authoritative terms used in one or more authoritative terminologies. For example, the mapping module 203 maps a source term “Sex=Boy” to an authoritative term “Gender=Male.” Further examples of the ontology mapping are illustrated in FIG. 11. The mapping module 203 stores the mapping as mapping data 145 in the database 138 and/or the storage 243.

An example ontology mapping is illustrated in Table 1.

TABLE 1
Ontology Mapping

| Source Column | Authoritative Column |
|---|---|
| Source ontology (non-authoritative | Authoritative ontology |
| ontology) | |
| Source terminology | Authoritative terminology |
| Source terms | Authoritative terms (Code list items) |
| Non-authoritative domains | Authoritative domains |
| Objects described by source | Objects described by authoritative |
| ontology | ontology |

The mapping module 203 determines mapping relationships for mapping items in a source column to corresponding items in an authoritative column as shown in Table 1. For example, the mapping module 203 determines mapping relationships between the source terminology and the authoritative terminology, which are also the mapping relationships between source terms and authoritative terms. The non-authoritative domains and authoritative domains are described below in more detail.

An object described by an authoritative ontology includes the same information as the corresponding object described by a source ontology. In some embodiments, the mapping module 203 maps objects described by a source ontology to corresponding objects described by the one or more authoritative ontologies using the mapping relationships. For example, the mapping module 203 maps one or more source terms describing the one or more objects to one or more corresponding authoritative terms based on the mapping relationships. In some embodiments, one or more source terms having the same meanings are mapped to a single authoritative term as illustrated in FIG. 11.

In some embodiments, the mapping module 203 applies one or more mapping strategies to map one or more objects described by a source ontology to one or more corresponding objects described by one or more authoritative ontologies. Examples of a mapping strategy include, but are not limited to, a standard mapping, an identity mapping, and a crowd source mapping.

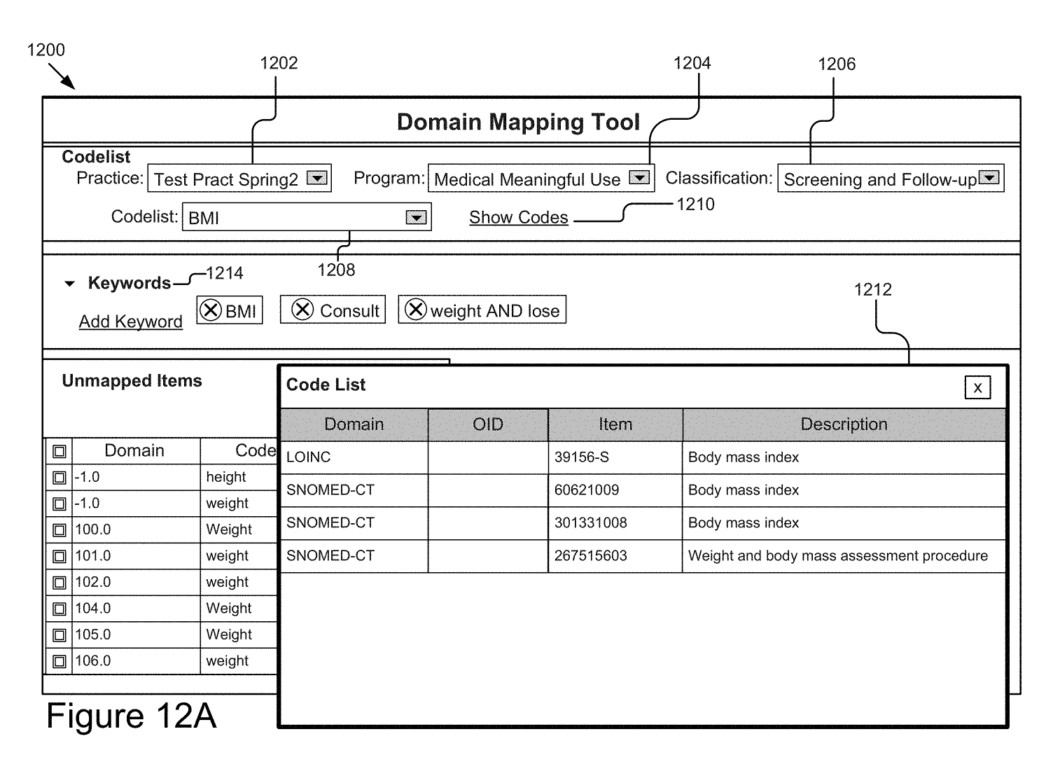

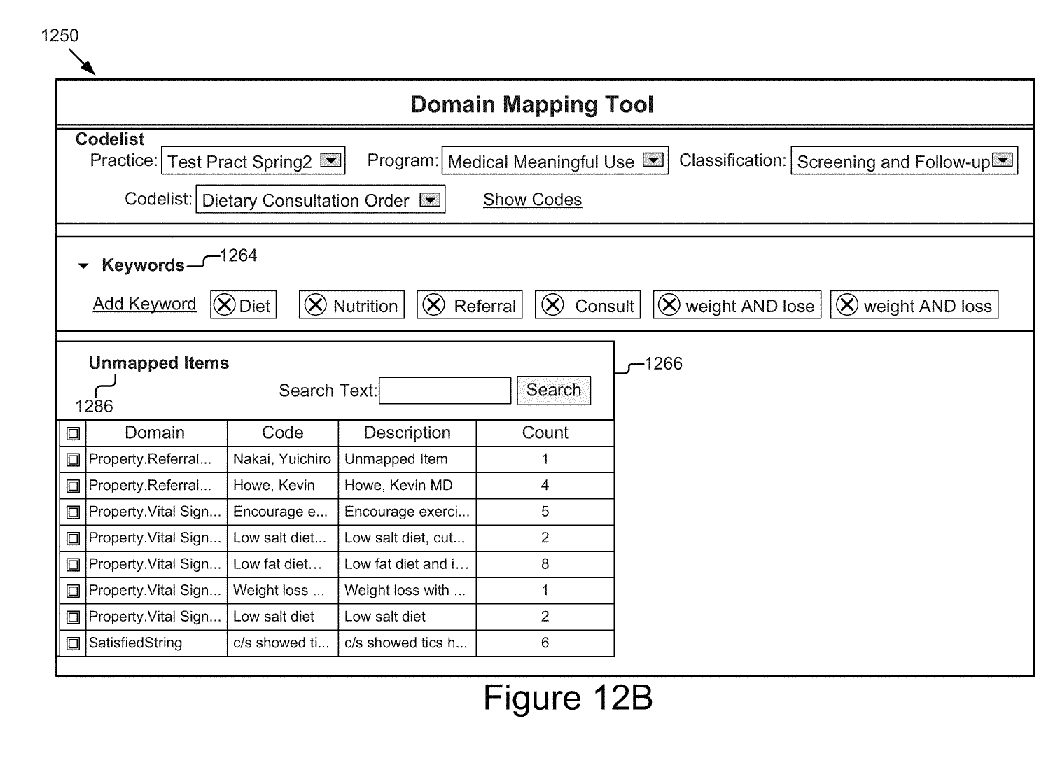

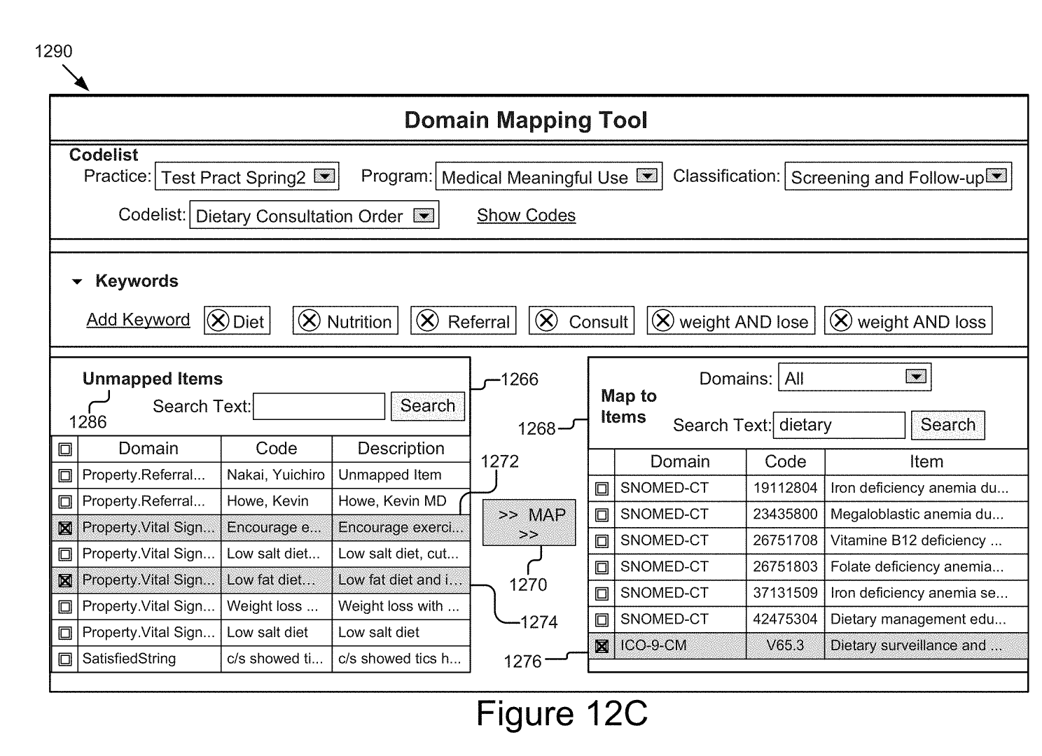

The standard mapping is a strategy to map a source term to an authoritative term based on input data from a user. For example, the mapping module 203 presents a source term and one or more candidate authoritative terms to a knowledgeable user (e.g., a medical service provider, such as a doctor, a nurse, or any other user trained to be a knowledgeable user) and receives input from the knowledgeable user indicating a candidate authoritative term that maps the source term. The mapping module 203 employs the standard mapping by mapping a source term to an authoritative term manually. Example user interfaces using a domain mapping tool to perform the standard mapping are illustrated in FIGS. 12A-12C.

The identity mapping is a strategy to map a source term to an authoritative term using a matching identity between the source term and the authoritative term. In some embodiments, the mapping module 203 performs the identity mapping automatically. For example, if the object received from the data source server 105 includes a property with an identity “ICD-9” and a value “540.0,” the mapping module 203 maps the property using the corresponding authoritative ICD-9 code with a number value 540.0. In another example, if the object includes a property with an identity “birth date” and a value “Jan. 10, 1990,” the mapping module 203 maps the property as a birth date with a value of Jan. 10, 1990 automatically. In yet another example, if the object includes a property with an identity “CPT” and a value “90658,” the mapping module 203 maps the property using the corresponding authoritative CPT code with a number value “90658,” which indicates a flu shot event.

In some embodiments, a data source provider transmits provider data 139 where a source term is already mapped to an authoritative term and provides the claimed mapping (e.g., an identity “ICD-9,” an identity “CPT,” etc.) to the mapping module 203. If the mapping is consistent with the mapping data 145 created by the mapping module 203, the provider data 139 with the mapping advantageously facilitates the ontology mapping and improves the quality and accuracy of the mapping. In some embodiments, the mapping module 203 ensures that the prover data 139 including mapping is consistent with how the mapping module 203 would map the provider data 139 before adding the provider data 139 to the mapping data 145 and using the provider data 139 in the identity mapping strategy.

The crowd source mapping is a strategy to map a source term to an authoritative term based on other data source providers' mapping behaviors. Even though a particular data source provider may use different terminology from another data source provider, as a whole a substantial number of data source providers use similar terminologies. In some embodiments, the mapping module 203 maps a source term received from a data source provider to a particular authoritative term because other data source providers also map the same source term to the same authoritative term.

In some embodiments, the mapping module 203 maps a source term received from a data source server 105 to a corresponding authoritative term if a credibility number threshold is satisfied. For example, the mapping module 203 maps a source term to a corresponding authoritative term if a total number of data source providers that map the source term to the same authoritative term meets or exceeds a credibility number threshold. For example, assume that at least 12 other data source providers map the source term “Sex=Boy” to the authoritative term “Gender=Male” and a credibility number threshold is configured as 10. The mapping module 203 automatically maps the source term “Sex=Boy” to the authoritative term “Gender=Male” because the number of data source providers that map the source term to the same authoritative term is greater than the credibility number threshold.

In some embodiments, the mapping module 203 maps a source term to a particular authoritative term if a percentage of data source providers that map the source term to the same authoritative terms meets or exceeds a credibility percentage threshold. For example, assume that at least 75% of the data source providers map the source term “Sex=Boy” to the authoritative term “Gender=Male” and a credibility percentage threshold is configured as 65%. The mapping module 203 automatically maps the source term “Sex=Boy” to the authoritative term “Gender=Male” because the percentage of the data source providers that map the source term to the same authoritative term is greater than the credibility percentage threshold.

In some embodiments, the mapping module 203 maps a source term to a particular authoritative term if the data source providers mapping either satisfies a credibility number threshold or a credibility percentage threshold. For example, assume that at least 12 data source providers that represent at least 75% of the providers map the source term “Sex=Boy” to the authoritative term “Gender=Male.” A credibility percentage threshold is configured as 65% and a credibility number threshold is configured as 10. The mapping module 203 automatically maps the source term “Sex=Boy” to the authoritative term “Gender=Male” for a data source provider, because both of the following conditions are satisfied: (1) the number of other providers that map the source term to the same authoritative term are greater than the credibility number threshold; and (2) the percentage of the data source providers that map the source term to the same authoritative term is greater than the credibility percentage threshold.

In some embodiments, a user of the data management application 103 may choose whether the crowd source mapping strategy is used during the ontology mapping. For example, a user may authorize or not authorize the mapping module 203 to apply the crowd source mapping strategy when mapping the provider data 139 to authoritative terms via a user interface generated by the user interface module 215. In some embodiments, a data source provider associated with a data source server 105 may choose to opt in or opt out of the mapping module 203 mapping its provider data 139 to authoritative terms. For example, the data source provider may indicative that the provider data 139 is not to be included in the determination of any credibility number threshold or credibility percentage threshold.

In some embodiments, the mapping module 203 applies a standard mapping when the data management application 103 is initially established for a user. Afterwards, the mapping module 203 may automatically apply the identify mapping and the crowd source mappings whole processing provider data 139 received from a data source provider. However, any objects that cannot be mapped automatically may need to be manually mapped to corresponding authoritative terms. In some embodiments, the mapping module 203 applies the standard mapping when a new configuration is set up for the data management application 103. For example, if a smoking status question in a classification structure is updated with additional responses or the smoking status question is moved from a Vital Signs to a Human Performance Improvement (HPI) screen in an electronic health record, the mapping module 203 may apply the standard mapping to map the objects related to the smoking status question.

In some embodiments, some of the provider data 139 received from the data source server 105 may be documented in text fields or as comments, which are more difficult to categorize using ontology mapping than the provider data 139 described in a structured format such as selectable observation results, treatment, or diagnoses. In some embodiments, a knowledgeable user instructs the mapping module 203 to manually map the provider data 139 to corresponding authoritative terms. for example, if a measurement result requires a patient to have a diagnosis of diabetes and the provider data 139 corresponding to the patient does not have an object labeled “diagnosis” or ‘ICD-9,” the provider data 139 would not be mapped to the authoritative term without a user instructing the mapping module 203 to map diabetes to the corresponding authoritative term for the diagnosis.

In some embodiments, a property of an object is referred to as a domain and a value for the property is referred to as a domain item (or, a term in the domain). For example, if a domain or a property is “gender,” a domain item or a value for the property can be ‘male” or female.” In another example, if a domain or a property is “smoking status,” a domain item or a value for the property can be “smoker,” “non-smoker,” and “ex-smoker.” In some embodiments, a domain is a question and the domain item is an answer to the question. In some embodiments, an authoritative term is referred to as an authoritative domain item. For example, an authoritative domain item can be a term from one of CPT, CVX, HCPCS, HL7, ICD-9, ICD-10, ICD-11, LONINC, RXNorm, Snomed, or Payer. In some embodiments, a source term is referred to as a non-authoritative domain item. For example, the mapping module 203 constructs domains for a data source provider using all the terms used by the data source provider and the provider domains are considered as non-authoritative domains.

After mapping the source ontologies to one or more authoritative ontologies, the mapping module 203 may represent the semantic web model describing the profile data 145 as a construction from a source ontology or a construction from an authoritative ontology, where both of the constructions include the same information and indicate the same semantic web model. The mapping module 203 normalizes the provider data 139 by organizing the provider data 139 as a semantic web model independent from any declarations. The semantic web model is not influenced by any specific choices made as to what to measure and now to make the measurement. The structure of the normalized provider data 139 does not need to be changed whenever new declarations are made or whenever new authoritative ontologies are brought in. In some embodiments, the mapping module 203 transmits the provider data 139 to the classification engine 209. In some embodiments, the mapping module 203 stores the provider data 139 in the database 138.

In some embodiments, the mapping module 203 receives user feedback and modifies the mapping based on the feedback. In some embodiments, the mapping module 203 uses machine learning to modify the mapping. For example, the mapping module 203 may use a training set to generate a model for applying the mapping of the source terms to corresponding authoritative terms, transforming provider data 139 into profile data 142, and determining how to generate a semantic web model of the profile data 142.

The mapping module 203 may instruct the user interface module 215 to generate a user interface that includes the mapping performed by the mapping module 203. If the user reviews the user interface and provides feedback about the mapping, the mapping module 203 revises the model based on the feedback. For example, the user may indicate that a source term was incorrectly mapped to a corresponding authoritative term. The feedback may include an identification of the correct corresponding authoritative term. Based on the feedback, the mapping module 203 may use machine learning to improve the mapping.

In some embodiments, the mapping module 203 uses machine learning to map source terms for the provider data 139 provided in text fields or as comments to corresponding authoritative terms.

The structure module 205 is code and routines that, when executed by the processor 235, creates a classification structure. The structure module 205 is communicatively coupled to the bus 220 via signal line 226. In some embodiments, the structure module 205 receives rule data describing one or more declarative classification rules from the declaration module 202 and determines one or more partitions based on the one or more declarative classification rules. For example, if a declarative classification rule defines how to partition patients into one or more disjoint subsets, the structure module 205 determines a partition that includes one or more disjoint classes with each class representing a disjoint subset.

A partition is data describing an ordered set of criteria used to classify each patient into a single class from the partition. The set of criteria are ordered so that each partition can classify each patient into only the earliest class that the patient satisfies when classifying the patient using the partition. In one embodiment, a partition includes two or more disjoint classes and each patient is classified into only a single class of the two or more disjoint classes. For example, a partition includes two disjoint classes: (1) a first class with patients under 5 years old; and (2) a second class with patients not less than 5 years old. In this example, when the partition is applied to classify the profile data 142, each patient is classified to one of the two disjoint classes.

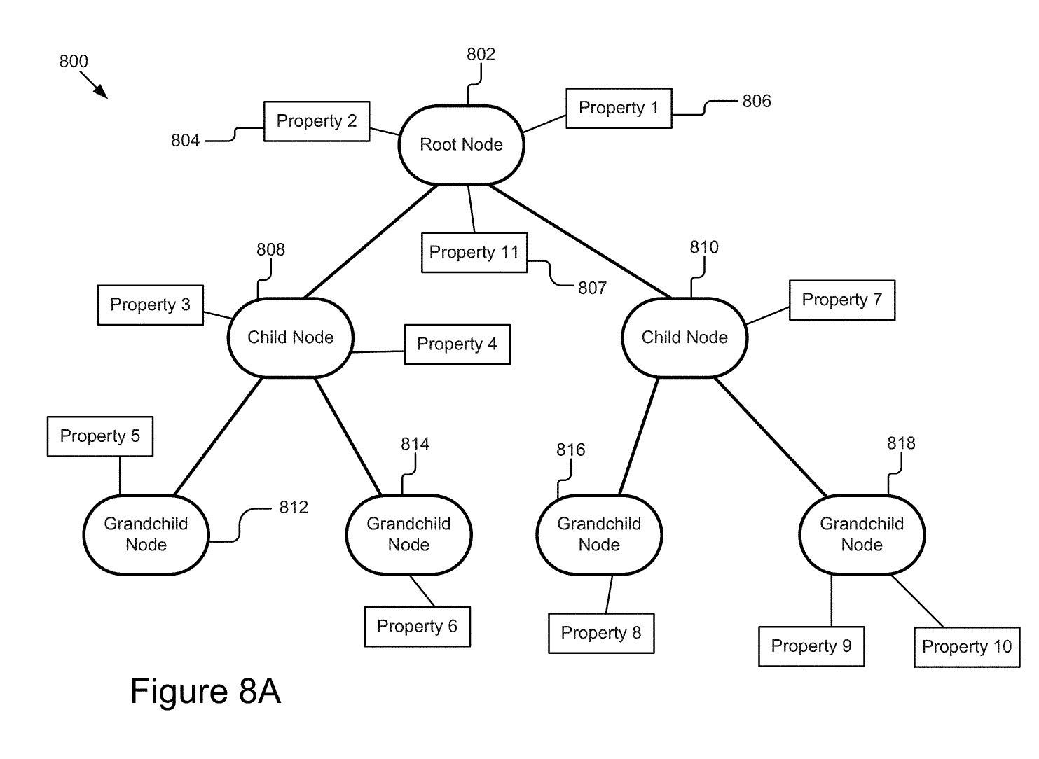

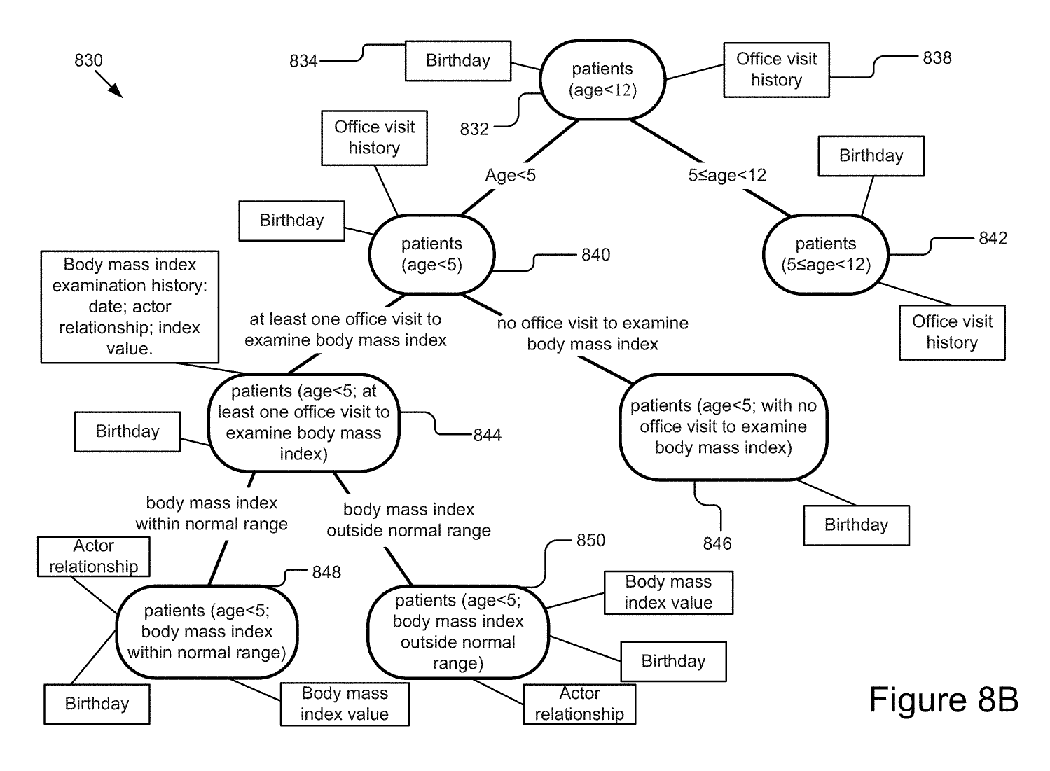

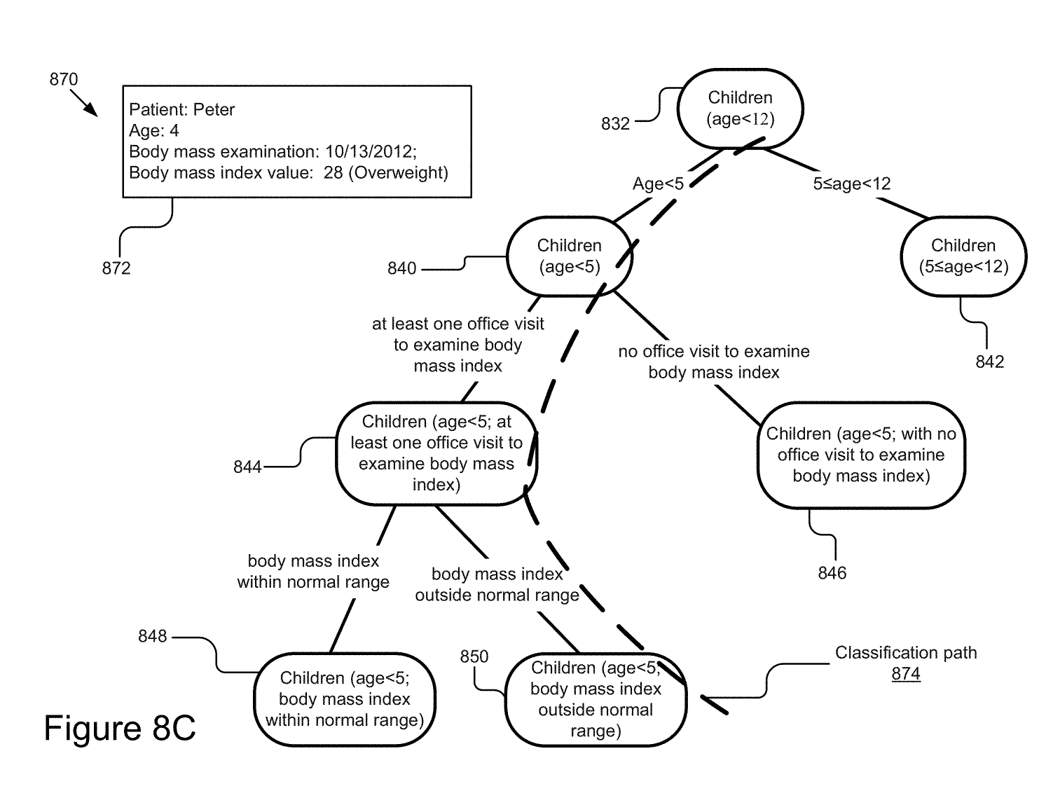

In one embodiment, the structure module 205 creates a classification structure that includes a set of partitions. A classification structure is a structure used to classify profile data 142 into one or more classes. For example, a classification structure is a classification tree (e.g., a classification structure organized in a tree form), a classification table (e.g., a classification structure organized in a table), and a classification graph (e.g., a classification structure organized as a graph). Examples of the classification structure are illustrated in FIGS. 8A-8C, 9 and 10. In some embodiments, the classification structure includes data describing a set of partitions and relationships between the partitions. In some embodiments, the classification structure and the partitions are created independently from the profile data 142.

In some embodiments, the set of partitions included in the classification structure are multi-level partitions. For example, the classification structure includes a root partition, one or more child partitions and one or more grandchild partitions, etc. In another example, the classification structure includes: (1) a root partition having a first root class (e.g., a root class of patients under 12 years old) and a second root class (e.g., a root class of patients above 12 years old); (2) a child partition which divides the first root class into a first child class (e.g., a child class of patients under 5 years old) and a second child class (e.g., a child class of patients between 5 years old and 12 years old); (3) a first grandchild partition which divides the first child class into a first grandchild class (e.g., a grandchild class of patients under 5 years old with normal body mass index) and a second grandchild class (e.g., a grandchild class of patients under 5 years old with abnormal body mass index); and (4) a second grandchild partition which divides the second child class into a third grandchild class (e.g., a grandchild class of patients between 5 years old and 12 years old with normal body mass index) and a fourth grandchild class (e.g., a grandchild class of patients between 5 years old and 12 years old with abnormal body mass index).

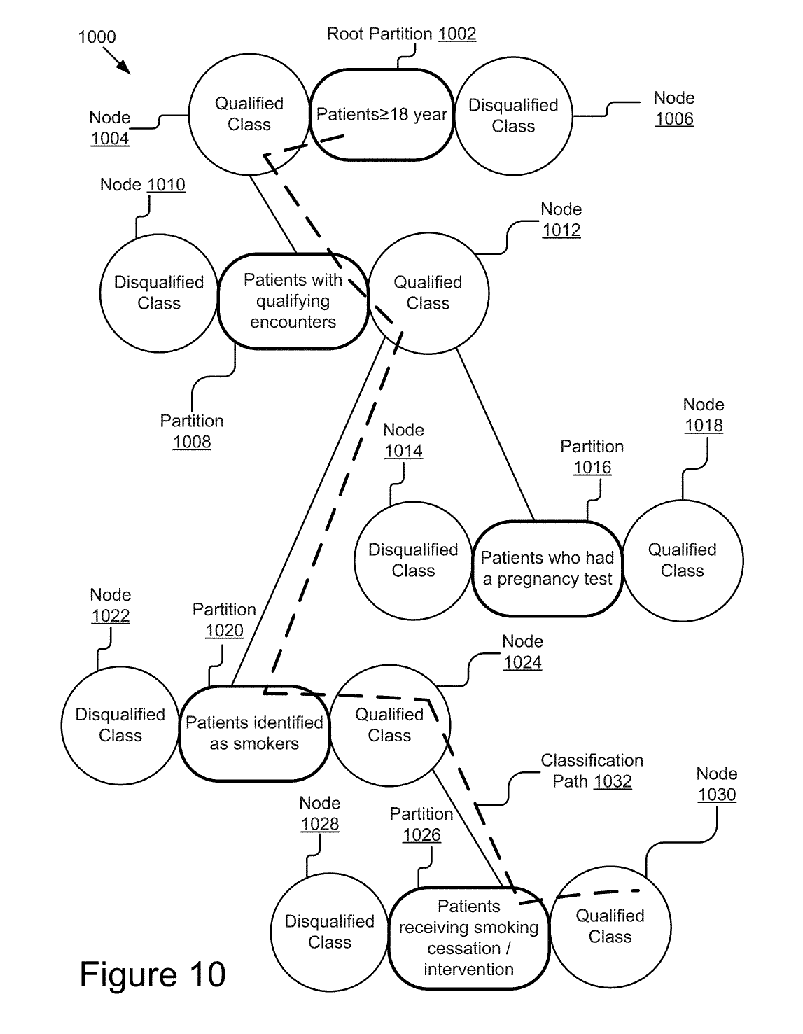

A parent class is a class in a parent partition, and a child partition divides the parent class into two or more child classes. Each partition (except the root partition) in the classification structure has a parent class. The root partition has no parent class. For example, a child partition, which has (1) a first child class of patients under 5 years old and (2) a second child class of patients between 5 years old and 12 years old, relates to a parent class representing patients under 12 years old. The first child class and the second child class are subsets of the parent class. In another example, with reference to FIG. 10, a partition 1002 is a parent partition of a partition 1008; a qualified class represented as a node 1004 is a class of the partition 1002 and also a parent class for the partition 1008; and nodes 1010 and 1012 represent two child classes of the parent class. FIG. 10 is described below in more detail.

The classification engine 207 is code and routines that, when executed by the processor 235, classifies each patient to one or more classes in a classification structure. The classification engine 207 is communicatively coupled to the bus 220 via signal line 227. In some embodiments, the classification engine 207 receives profile data 142 from the mapping module 203 where the profile data 142 is organized as a semantic web model. The profile data 142 describes one or more objects associated with a patient in authoritative domains.

In some embodiments, the classification engine 207 applies a classification structure to the profile data 142 and classifies each patient described in the profile data 142 to one or more classes (e.g., one or more final classes as described below) in the classification structure. For example, the classification engine 207 applies a classification structure to profile data 142 describing a group of patients, so that each patient goes through the classification structure by starting at the root partition and descending to a root class of the root partition if the patient satisfies criteria of the root class, going through a child partition and descending to a child class of the child partition if the patient satisfies criteria of the child class, so on and so forth, until the patient arrives at a final class in the classification structure.

A final class for a patient is the last class in the classification structure that the patient satisfies. In some embodiments, a final class is the last class where the patient is classified to in the classification structure. For example, when applying a classification structure illustrated in FIG. 8C to classify a patient under 5 years old with abnormal body mass index, the final class for the patient is the class of “children (age <5 years old and body mass index outside normal range),” which is represented as a node 850.

The path that a patient goes through starting at a root partition and ending at a final class is referred to as a classification path for the patient in the classification structure. A classification path is a path in a classification structure along which profile data 142 describing a patient is processed. Examples of a classification path are illustrated in FIGS. 8C and 10. Different patients may have the same classification path or different classification paths.

Each class (e.g., root class, child class, etc.) is also referred to as a node (e.g., root node, child node, etc.) in the classification structure. Examples of the nodes in a classification structure are illustrated in FIGS. 8A-8C and 10. As a result of the classification process, each node in the classification structure includes a subset of patients that satisfies the criteria associated with the node. For example, a node of “children under 5 years old” includes a subset of patients that are less than 5 years old. In another example, a node of “children under 5 years old with abnormal body mass index” includes a subset of patients that are less than 5 years old and have abnormal body mass index.

In some embodiments, a node is associated with a combination of criteria and a patient needs to satisfy the combination of criteria in order to descend to the node from a root node in a classification structure. For example, assume a classification path from a root node to a grandchild node starts at the root node, goes through a child node and ends at the grandchild node. The root node is associated with a first criterion to be satisfied in order to classify patients to the root node. The child node is associated with a combination of criteria including the first criterion and a second criterion that is to be satisfied in order to classify patients to the child node from the root node. The grandchild node is associated with a combination of the first criterion, the second criterion and a third criterion that is to be satisfied in order to classify patients to the grandchild node from the child node.

In some embodiments, criteria associated with a node are described using code lists, each of which include items from one or more authoritative domains such as ICD codes, CPT codes, LOINC, Snomed, etc., and the classification engine 207 determines whether the profile data 142 describing a patient satisfies the code list items associated with the node. If the profile data 142 satisfies the code list items and other constraints/criteria (e.g., an age constraint such as less than 5 years old, a date constraint such as the date of the lab being within 3 days of the diagnosis, etc.) associated with the node, the classification engine 207 determines that the patient satisfies the node. If the profile data 142 does not satisfy the code list items associated with the node or the other constraints/criteria, the classification engine 207 determines that the patient does not satisfy the node.

In some embodiments, the classification engine 207 classifies a patent to a single class of a partition in the classification structure. In another embodiment, the classification engine 207 classifies a patient described by the profile data 142 to two or more classes (e.g., two or more final classes) in the classification structure. The classification path for the patient therefore has two or more branches with each branch going through one of the two or more final classes. The two or more final classes are classes each from a different partition. For example, a first parent class is a class of patients having vital signs observation, and is partitioned into a first child class of patients with blood pressure measurements and a second child class of patients with pulse rate measurement. A second parent class is a class of patients having tuberculosis tests, and is partitioned into a third child class of patient with positive test results and a fourth child class of patients with negative test results. In this example, a patient having a blood pressure measurement and a negative tuberculosis test result is classified to the first child class from the first parent class and a fourth child class from the second parent class. The first parent class and the second parent class are divided by different partitions.

In some embodiments, the classification engine 207 determines one or more timestamps for each patient who is classified into one or more classes in the classification structure. Each timestamp identifies a time the patient entered one of the one or more classes. For example, assume a patient is classified into a first class with a negative tuberculosis test result and a second class with an abnormal body mass index value. The Tuberculosis test was performed on May 20, 2011 and the body mass index examination was performed on Sep. 21, 2012. The classification engine 207 determines a first timestamp when the patient entered the first class as May 20, 2011 and a second timestamp when the patient entered the second class as Sep. 21, 2012.

In some embodiments, the classification engine 207 generates a timeline for the patient that includes the one or more timestamps. A timeline is data organized in time that describes one or more objects associated with a patient. In some embodiments, a timeline includes one or more assertions and/or events associated with a patient and organized in a chronological order. In another embodiment, a timeline is organized according to how a specialist (e.g., a doctor, a nurse, etc.) characterizes the objects. For example, a timeline includes data describing one or more of: when a patient entered a hospital and when the patient left the hospital; what diseases the patient contracted over time; what treatments the patient received over time; what medicines were prescribed to the patient over time; and how much treatment cost the patient paid over time, etc. In another example, for a class with patients under 5 years old, each patient's timeline indicates the patient: (1) entering the class at birth; (2) being in the class uninterrupted until the 5th birthday; and (3) exiting the class at the 5th birthday and not re-entering the class any more. In yet another example, if a class requires a patient's body mass index (BMI) to be within a certain range, the timeline for the patient illustrates (1) the patient entering the class on the day when a BMI in the range is recorded and (2) the patient leaving the class when either the recorded BMI expires or a BMI outside the range is recorded. The patient may re-enter the class when another BMI in the range is recorded. Other examples of a timeline are possible.

In some embodiments, the classification engine 207 sends data describing the timeline to one or more of the filtering module 211 and the search module 213. In another embodiment, the classification engine 207 stores data describing the timeline in the storage 243 or the database 138.

The measurement module 209 is code and routines that, when executed by the processor 235, performs one or more measurements for a classification structure. The measurement module 209 is communicatively coupled to the bus 220 via signal line 228. In some embodiments, the measurement module 209 generates one or more measurement results from a classification structure as described below. Any number of measurement results can be generated from a classification structure.

In some embodiments, a measurement result is a result that has “passed” or “failed” in a pass-or-fail test. For example, if a numeric score from a measurement is above a score threshold, the measurement result indicates a pass in a pass-or-fail test. However, if the numeric score is not greater than the score threshold, the measurement result indicates a failure in the pass-or-fail test. In some embodiments, the score threshold is configured by an administrator of the system 100. The numeric score is described below in more detail.

In another embodiment, a measurement result is a numeric score. The measurement module 209 transforms a classification structure into one or more numeric scores by taking one or more measurements in the classification structure. For example, the measurement module 209 determines a numerator as a total number of patients in a first node of a classification structure and a denominator as a total number of patients in a second node of the classification structure. A denominator and a numerator each can be a total number of patients in any node of a classification structure. The measurement module 209 determines a numeric score as a ratio between the numerator and the denominator. For example, a numeric score is determined as:

$$numeric score = \frac{numerator}{denominator} .$$

For example, assume a denominator has 5,000 patients in a node of “children under 5 years old” and a numerator has 4,900 patients in a node of “children under 5 years old with normal body mass index.” A numeric score indicating a percentage of children under 5 years old with normal body mass index can be determined as:

$$numeric score = \frac{numerator}{denominator} = \frac{4900}{5000} = 0.98 .$$

In some embodiments, the measurement module 209 determines an exclusion class for a measurement in a classification structure. An exclusion class is a class of patients who are to be excluded in a measurement. For example, for a measurement describing patients having abnormal body mass index, an exclusion class can be a group of pregnant patients. In some embodiments, the measurement module 209 takes a measurement in a classification structure by determining: (1) a numerator as a total number of patients in a first node of the classification structure; (2) a denominator as a total number of patients in a second node of the classification structure; and (3) an exclusion class for the measurement. If patients in the exclusion class are qualified for the numerator (e.g., the patients in the exclusion class are part of the patients in the numerator), the measurement module 209 determines a numeric score for the measurement as:

$$numeric score = \frac{numerator - exclusion}{denominator} .$$

However, if patients in the exclusion class are not qualified for the numerator, the measurement module 209 determines a numeric score for the measurement in a standard way:

$$numeric score = \frac{numerator - exclusion}{denominator - exclusion} .$$

The measurement results provide valuable information to providers, specialists (e.g., doctors), patients and other entities having authorized access to the information. For example, a measurement result indicates a percentage of children having abnormal body mass index. In another example, a measurement result indicates a percentage of smokers who have diagnosed with lung diseases. In yet another example, a measurement result indicates a cure rate for a disease when a special treatment is applied. Other examples of a measurement result are possible.

In some embodiments, the measurement module 209 stores data describing one or more measurement results in the storage 243. In another embodiment, the measurement module 209 sends the data describing the one or more measurement results to the filtering module 211 and/or the search module 213.

The filtering module 211 is code and routines that, when executed by the processor 235, filters one or more measurement results and/or a timeline based on one or more filtering parameters. The filtering module 211 is communicatively coupled to the bus 220 via signal line 230. A filtering parameter is data used to filter a result. Examples of a filtering parameter include, but are not limited to, a time parameter (e.g., within 12 months), demographic data associated with patients, geographic data associated with patients, doctor specific data (e.g., filtering results based on one or more doctors), practice specific data (e.g., filtering results based on a practice), procedure data, treatment cost, treatment received, medicine, etc.

In some embodiments, the filtering module 211 receives one or more measurement results from the measurement module 209 and/or a timeline from the classification engine 207. The filtering module 211 filters the one or more measurement results and/or the timeline based on one or more filtering parameters. For example, the filtering module 211 filters a timeline for a patient based on a time parameter within the last 5 years and doctor specific data related to a particular doctor, so that a filtered timeline is generated describing diagnosis reached by the doctor, treatments ordered by the doctor and medicine prescribed by the doctor, etc., within the last 5 years. In another example, the filtering module 211 cooperates with the measurement module 209 to filter a measurement result describing a trending of a diabetes rate within the last 10 years based on a geographic location, so that a filtered measurement result describing a trending of a diabetes rate within the last 10 years in the particular geographic location is generated. In yet another example, the filtering module 211 cooperates with the measurement module 209 to filter a measurement result describing a percentage of patients having an abnormal body mass index based on demographic data, so that a filtered measurement result describing a percentage of patients having an abnormal body mass index and satisfying the demographic data is generated. The filtering module 211 sends the filtered timeline and/or measurement results to the search module 213.

The search module 213 is code and routines that, when executed by the processor 235, receives a query, retrieves search results, and generates a report. The search module 213 is communicatively coupled to the bus 220 via signal line 232.

In some embodiments, the search module 213 receives a query that includes search terms for data files that correspond to the search terms. For example, the query may include a request for data files for a particular patient during a specified time range. The search module 213 retrieves search results that correspond to the data files from the database 138. For example, the search module 213 retrieves the data files for the patient during the specified time range.

In some embodiments, the search module 213 generates a report that includes the search results. In some embodiments, the search module 213 receives a timeline and/or one or more measurement results from the classification engine 207, the measurement module 209 and/or the filtering module 211. The search module 213 generates a report that includes the timeline and/or the one or more measurement results. In some embodiments, data in the report is organized based on one or more of: a time parameter indicating a time window for the data; demographic data related to a patient or a population of patients; geographic data related to the patient or the population of patients; treatment cost; doctor specific data; practice specific data; procedural data; medicine prescribed over time; and treatment received over time. For example, the search module 213 generates a report that includes measurement results related to a practice, measurement results related to each doctor in the practice and/or measurement results related to each department in the practice, etc., within the last 5 years.

In some embodiments, the search module 213 generates a report that includes a timeline describing one or more of when a patient entered a hospital and when the patient left the hospital, what diseases the patient contracted over time, what treatments the patient received over time, what medicines were prescribed for the patient over time and how much treatment cost the patient paid over time, etc. In some embodiments, the timeline includes a time window such as within 12 months, within 10 years, etc. In some embodiments, the search module 213 generates a report in a machine readable format such as the Physician Quality Reporting Initiative (PQRI) Registry extensible markup language (XML) Specification.

In some embodiments, the search module 213 generates the report using near real-time data. In some embodiments, the search module 213 customizes the report for a patient using patient-specific data. For example, the search module 213 generates a report for a patient that includes personalized treatment, patient-specific medicine and measurement results related to the patient. In some embodiments, the search module 213 receives predictive data describing one or more predictions of hospitalization, health condition in future, potential treatments and treatment cost and potential office visits in future, etc., related to a patient from the prediction module 217. The search module 213 includes the predictive data in a customized report for a patient.

In some embodiments, the search module 213 stores report data describing the report in the storage 243. In another embodiment, the search module 213 sends the report data to the user interface module 215.

The user interface module 215 is code and routines that, when executed by the processor 235, generates graphical data for providing user interfaces to users. The user interface module 215 is communicatively coupled to the bus 220 via signal line 234. In some embodiments, the user interface module 215 receives a declarative classification rule from the declaration module 202 and generates graphical data for providing a user interface based on the declarative classification rule. For example, the user interface module 215 generates graphical data that depicts one or more fields in a user interface according to a declarative classification rule. The user interface module 215 sends the graphical data to a client device 115, causing the client device 115 to present the user interface to a user. The user interface allows a user to input a declaration via the user interface. An example user interface is illustrated with reference to FIG. 6. In some embodiments, the user interface module 215 generates graphical data for providing one or more user interfaces in a domain mapping tool. Example user interfaces are illustrated with reference to FIGS. 12A-12C. In other embodiments, the user interface module 215 may generate graphical data for providing other user interfaces.

The prediction module 217 is code and routines that, when executed by the processor 235, conducts a predictive modeling for patients. The prediction module 217 is communicatively coupled to the bus 220 via signal line 265. A predictive modeling is data to predict one or more future events for a patient. For example, a predictive modeling predicts one or more of hospitalization risks, health condition in future, potential treatments, treatment cost and potential office visits in future, etc., related to a patient.

In some embodiments, the prediction module 217 conducts a predictive modeling for a patient using medical history data related to the patient upon the consent of the patient and/or measurement results obtained from the classification structure. For example, assume the medical history data indicates that a patient contracted a disease in last week and a measurement result from a classification structure indicates that 90% of patients who had the disease recovered within a month if a particular treatment is applied within two weeks of the contraction. The prediction module 217 conducts a predictive modeling for the patient that includes the particular treatment, a potential treatment duration, a potential hospitalization risk and an estimate of the treatment cost. The prediction module 217 sends predictive data describing the predictive modeling to the search module 213.

### Methods

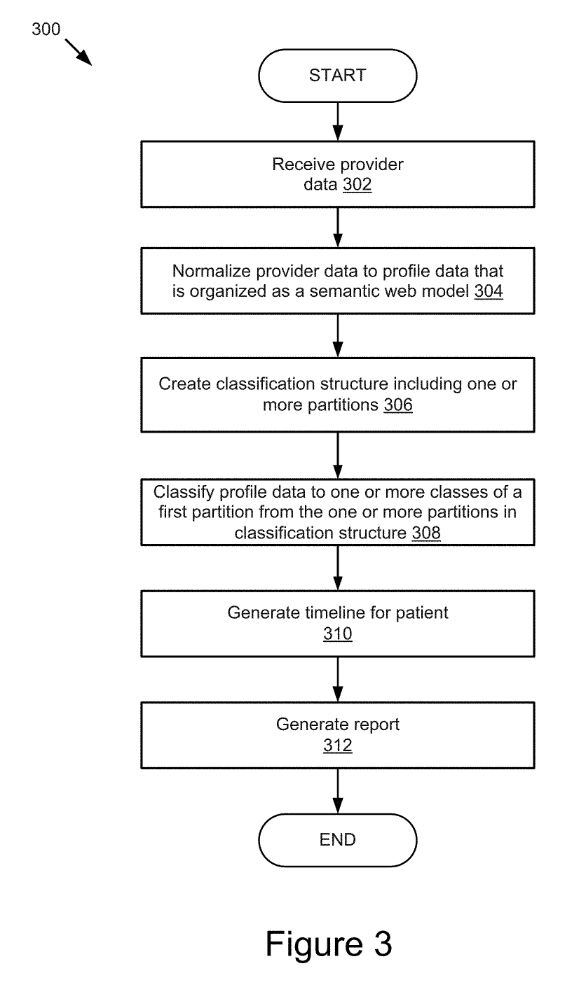

Referring now to FIGS. 3-5, various embodiments of the method of the specification will be described. FIG. 3 is a flowchart illustrating a method 300 for managing provider data 139 according to some embodiments. The communication module 201 receives 302 provider data 139 describing one or more objects associated with a patient from one or more data source servers 105 via the network 135. The mapping module 203 normalizes 304 the provider data to profile data 142 that is organized as a semantic web model. The structure module 205 creates 306 a classification structure that includes one or more partitions. The classification engine 207 classifies 308 the profile data 142 to one or more classes of a first partition from the one or more partitions in the classification structure. The classification engine 207 generates 310 a timeline for the patient. The search module 213 generates 312 a report for the patient.

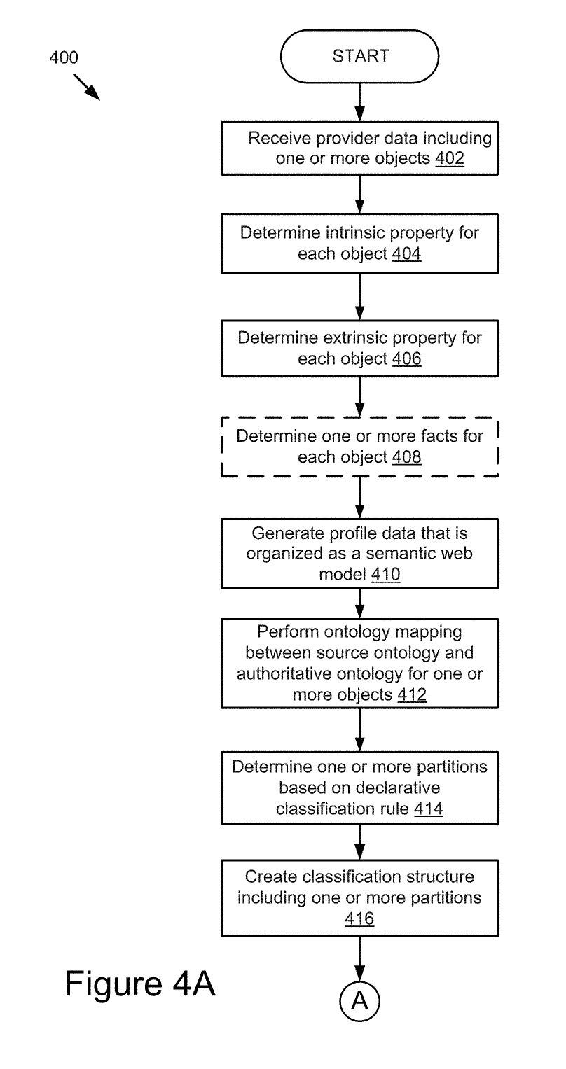

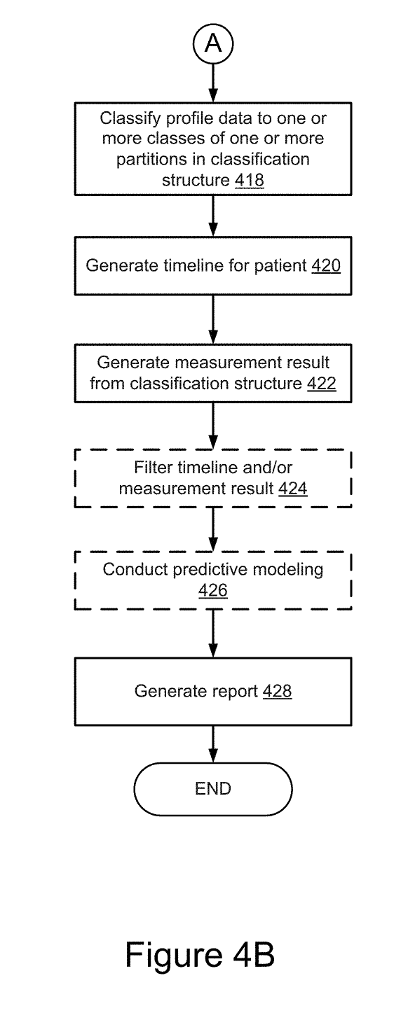

FIGS. 4A and 4B are flowcharts illustrating a method 400 for managing provider data according to another embodiment. Referring to FIG. 4A, the communication module 201 receives 402 provider data 139 including one or more objects associated with one or more patients. The mapping module 203 determines 404 one or more intrinsic properties for each object. The mapping module 203 determines 406 one or more extrinsic properties for each object. The mapping module 203 optionally determines 408 one or more facts for each object. The mapping module 203 generates 410 profile data 142 that is organized as a semantic web model from the one or more objects. The mapping module 203 performs 412 ontology mapping between source ontologies and authoritative ontologies for the one or more objects. The structure module 205 determines 414 one or more partitions based on one or more declarative classification rules. The structure module 205 creates 416 a classification structure including the one or more partitions.

Referring to FIG. 4B, the classification engine 207 classifies 418 the profile data 142 to one or more classes of one or more partitions in the classification structure. The classification engine 207 generates 420 a timeline for each patient. The measurement module 209 generates 422 one or more measurement results from the classification structure. Optionally, the filtering module 211 filters 424 the timeline for each patient and the one or more measurement results. Optionally, the prediction module 217 conducts 426 a predictive modeling for each patient. The search module 213 generates 428 a report for each patient.

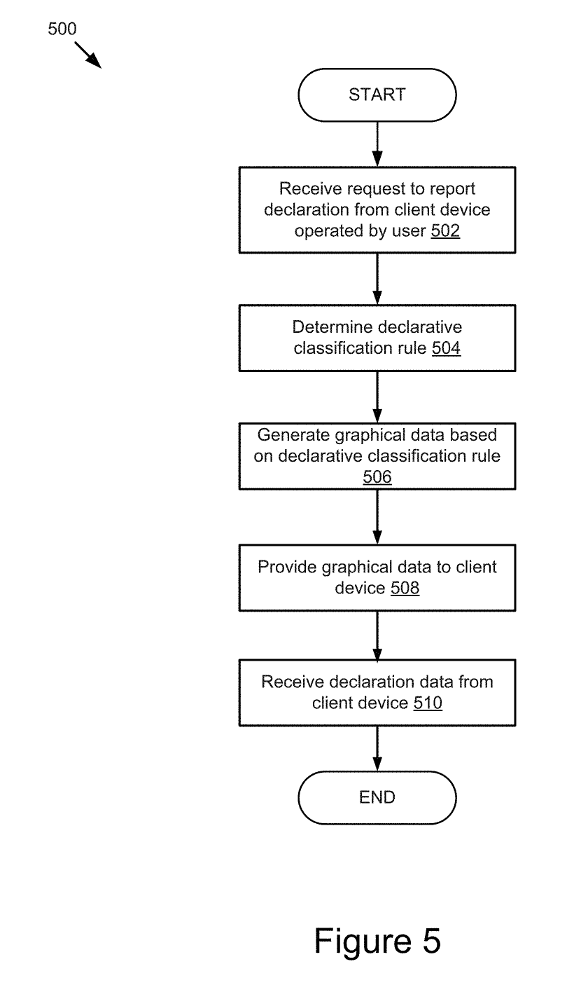

FIG. 5 is a flowchart illustrating a method 500 for receiving one or more declarations according to some embodiments. In some implementations, the communication module 201 receives 502 a request to report a declaration from a client device 115 operated by a user via the network 135. The declaration module 202 determines 504 a declarative classification rule. The user interface module 215 generates 506 graphical data based on the declarative classification rule. The user interface module 215 provides 508 the graphical data to the client device 115, causing the client device 115 to present a use interface to the user. The user can input declaration data via the user interface. After the user submits the declaration, the communication module 201 receives 510 the declaration data from the client device 115 and sends the declaration data to the declaration module 202.

### Graphic Representations

FIG. 6 is a graphic representation 600 illustrating an example user interface for receiving a declaration according to some embodiments. The example user interface includes data describing a user 602 “Bob XYZ.” The user 602 can provide a declaration related to a patient by filling out the fields in the section 608. The user 602 can submit the declaration by clicking on a “Submit Declaration” button 604. The user 602 may cancel the declaration by clicking on a “Cancel Declaration” button 606.

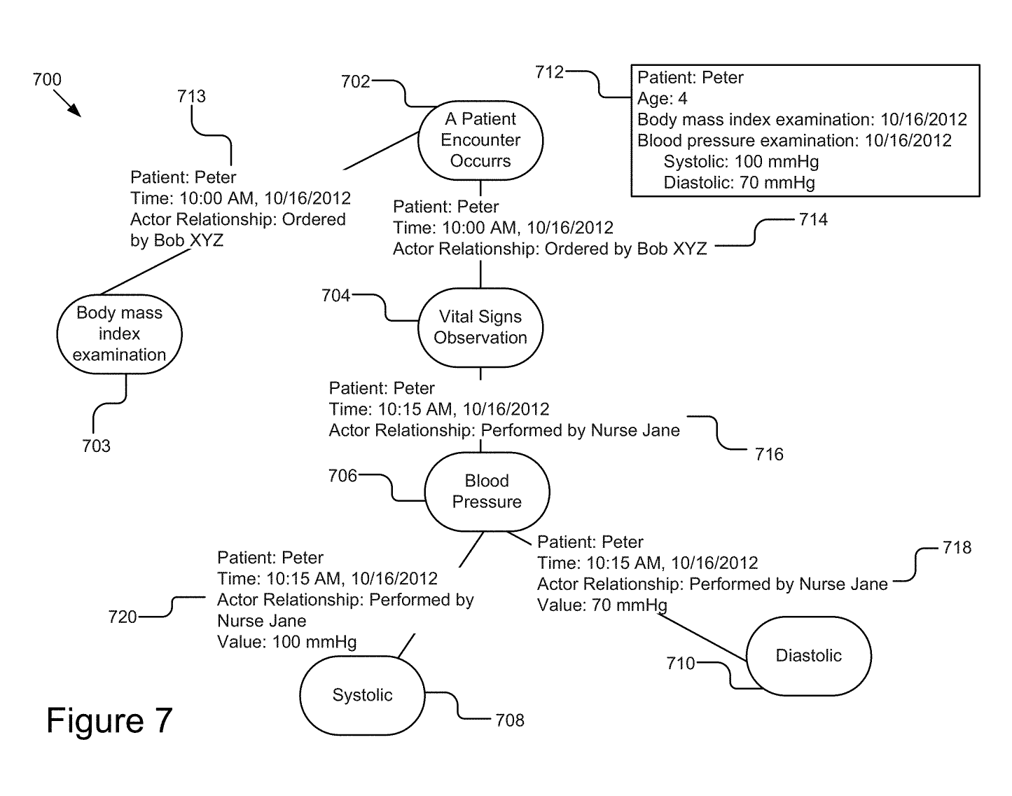

FIG. 7 is a graphic representation 700 illustrating example profile data 142 that is organized in a semantic web model according to some embodiments. A box 712 includes provider data describing a patient Peter. In the illustrated embodiment, the objects 702, 703, 704, 706, 708, 710 associated with the patient Peter are organized as classes in a semantic web model. The properties and/or facts 713, 714, 716, 718, 720 associated with the objects are organized as links between classes in the semantic web model. For example, the object 706 representing a blood pressure measurement, the object 708 representing a systolic result for a blood pressure measurement and the object 710 representing a diastolic result for a blood pressure measurement are classes of the semantic web model. The properties 720 indicating a patient named Peter, a time, an actor relationship and a value for the systolic result are represented as links between the object 706 and the object 708. The properties 718 indicating the patient named Peter, a time, an actor relationship and a value for the diastolic result are represented as links between the object 706 and the object 710.

FIG. 8A is a graphic representation 800 illustrating a classification structure in a high-level according to some embodiments. The illustrated classification structure includes a root node 802 and one or more properties 804, 806, 807 associated with the root node 802. The classification structure has multi-level partitions. For example, a first partition divides the root node 802 into a first child node 808 and a second child node 810. A second partition divides the child node 808 into two grandchild nodes 812, 814. A third partition divides the child node 810 into two other grandchild nodes 816 and 818. The nodes 808, 810, 812, 814, 816, 818 each may have one or more properties and/or facts.

FIG. 8B is a graphic representation 830 illustrating an example classification structure according to some embodiments. The example classification structure has a root node 832 representing patients under 12 years old, a first property 834 of the node 832 indicating a birthday of each patient and a second property 838 of the node 832 indicating an office visit history for each patient. The root node 832 is partitioned into a first node 840 representing patients under 5 years old and a second node 842 representing patients between 5 years old and 12 years old. The node 840 is partitioned into a first node 844 representing patients under 5 years old with at least one office visit to examine body mass index and a second node 846 representing patients under 5 years old with no office visit to examine body mass index. The node 844 is further partitioned into a first node 848 representing patients under 5 years old with normal body mass index and a second node 850 representing patients under 5 years old with abnormal body mass index. Each of the nodes 840, 842, 844, 846, 848 and 850 has one or more associated properties depicted as rectangles connected to the respective node.

FIG. 8C is a graphic representation 870 illustrating an example classification process applied to an example classification structure according to some embodiments. In the illustrated embodiment, a box 872 describes a patient Peter who is 4 years old and had body mass examination on Oct. 13, 2012 with an index value 28 (overweight). The patient Peter is classified to a node 850 in the example classification structure because the patient Peter satisfies all the criteria associated with the nodes 832, 840, 844 and 850. A classification path 874 for the patient Peter is illustrated in FIG. 8C, which begins at the node 832, goes through the nodes 840 and 844 and ends at the node 850. The node 850 represents a final class in the example classification structure that the patient Peter is classified to.

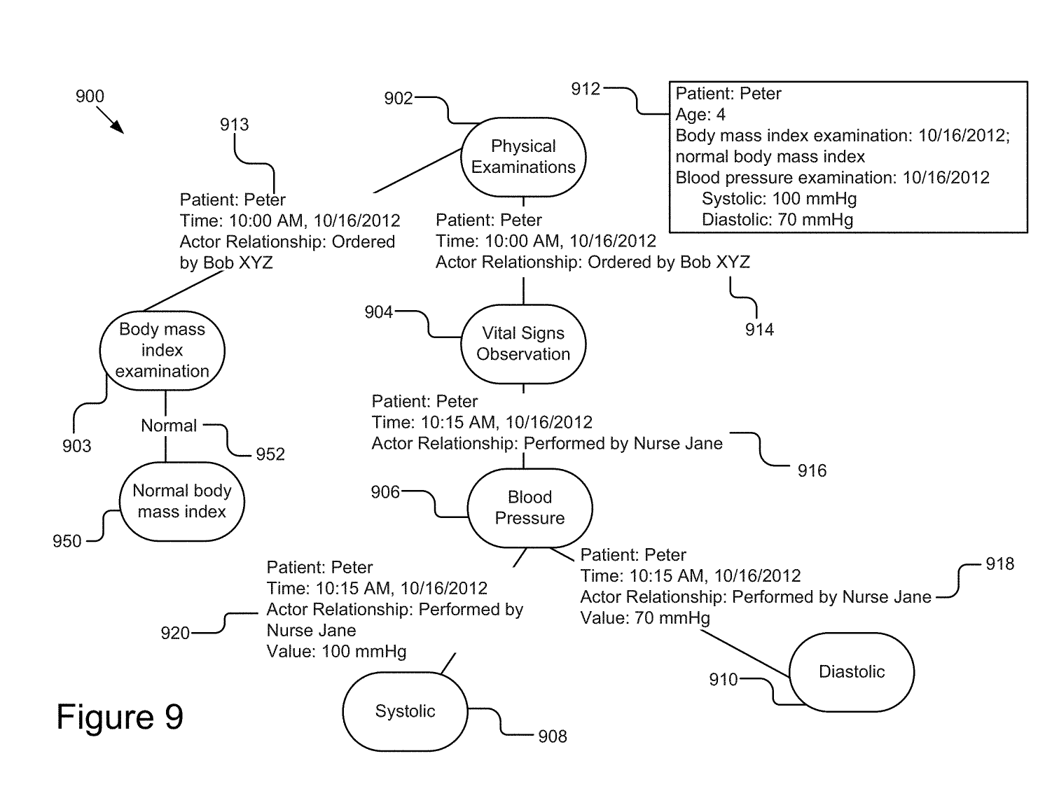

FIG. 9 is a graphic representation 900 illustrating example profile data 142 that is organized as a semantic web model according to another embodiment. In the illustrated embodiment, a box 912 describes a patient Peter who is 4 years old and had body mass examination on Oct. 16, 2012 (with a normal result) and a blood pressure examination on Oct. 16, 2012 (systolic: 100 mmHg, diastolic: 70 mmHg). In the illustrated embodiment, the objects 902, 904, 906, 908, 910, 903, 950 are organized as classes in a semantic web model. The properties and/or facts 914, 916, 918, 920, 913, 952 associated with the patient Peter are organized as links between classes in the semantic web model.

FIG. 10 is a graphic representation 1000 illustrating an example classification structure according to some embodiments. The example classification structure includes a root partition 1002 representing patients not less than 18 years old. The root partition 1002 divides patients into a qualified class (represented as a node 1004) which satisfies the criteria of the root partition 1002 and a disqualified class (represented as a node 1006) which does not satisfy the criteria of the root partition 1002. The node 1004 is divided by a partition 1008 representing patients with qualifying encounters. The partition 1008 divides the node 1004 into a qualified class (represented as a node 1012) which satisfies the criteria of the partition 1008 and a disqualified class (represented as a node 1010) which does not satisfy the criteria of the partition 1008.

The node 1012 is divided by a partition 1016 representing patients who had a pregnancy test. The partition 1016 divides the node 1012 into a qualified class (represented as a node 1018) which satisfies the criteria of the partition 1016 and a disqualified class (represented as a node 1014) which does not satisfy the criteria of the partition 1016.

The node 1012 is also divided by a partition 1020 representing patients identified as smokers. The partition 1020 divides the node 1012 into a qualified class (represented as a node 1024) which satisfies the criteria of the partition 1020 and a disqualified class (represented as a node 1022) which does not satisfy the criteria of the partition 1020. The node 1024 is divided by a partition 1026 representing patients receiving smoking cessation and/or intervention. The partition 1026 divides the node 1024 into a qualified class (represented as a node 1030) which satisfies the criteria of the partition 1026 and a disqualified class (represented as a node 1028) which does not satisfy the criteria of the partition 1026.

If the example classification structure is applied to a patient who is 20 years old and has received smoking cessation, the patient is classified to the node 1030. The patient satisfies all the criteria associated with the partitions 1002, 1008, 1020, 1026 and the nodes 1004, 1012, 1024, 1030. A classification path 1032 for the patient includes the partitions 1002, 1008, 1020, 1026 and the nodes 1004, 1012, 1024, 1030.

FIG. 11 is a graphic representation 1100 illustrating an example ontology mapping according to some embodiments. In the illustrated embodiment, source terms “ICD-9-V72.0” and “Diagnosis-Vision Exam” are mapped to an authoritative term “ICD-9-V72.0.” A source term “Encounter-Nurse Visit” is mapped to an authoritative term “CPT-99211.”

FIGS. 12A-12C are graphic representations 1200, 1250, 1290 illustrating example user interfaces for performing ontology mapping according to some embodiments. The example user interfaces illustrate using a domain mapping tool to map source domains to authoritative domains. As described below, an example standard mapping using a domain mapping tool can be performed by: (1) choosing a specific classification; (2) searching for any unmapped items that match the code lists used by the classification; (3) selecting an unmapped item; (4) searching for a matching code list item; and (5) mapping the unmapped item to the matching code list item.

Referring to FIG. 12A, a user selects a practice via a dropdown box 1202 and a program for the practice via a dropdown box 1204. The user can select a classification from a dropdown box 1206. After selecting the classification, a dropdown box 1208 for selecting a code list is populated. The user selects a code list via the dropdown box 1208. The user can perform the mapping process for each code list associated with the selected classification. Each code list has a pre-loaded list of keywords 1214 which facilitate the search of unmapped items (e.g., unmapped objects). The domain mapping tool automatically searches for unmapped items in the provider data after the code list is selected in the dropdown box 1208. The unmapped items are described below in more detail with reference to FIG. 12B.

If the user clicks on a “Show Codes” link 1210, a code list is shown in a box 1212. The code list includes a domain column listing authoritative domains, an OID column for internal use, an item column listing codes used by the authoritative domains to identify a particular data item and a description column listing descriptions for data items.

Referring to FIG. 12B, in some embodiments a user selects a practice, a program, a classification and a code list by performing operations similar to those described above with reference to FIG. 12A. The descriptions will not be repeated here. The user selects one or more keywords 1264. The domain mapping tool searches for one or more unmapped items 1286 under the selected code list. The unmapped items 1286 are displayed in a box 1266. Each unmapped item has a domain (representing a source domain), a code, a description for the unmapped item and a count. When the source domain is equivalent to an authoritative domain, the code is recognizable as an ICD-9 or CPT code. The count is the number of times that the unmapped item appears in the selected practice's provider data. The user can sort the unmapped items 1286 by each column (e.g., a domain column, a code column, a description column or a count column). The unmapped items 1286 can be mapped to authoritative items as illustrated in FIG. 12C.

Referring to FIG. 12C, the example user interface displays the unmapped items 1286 and a box 1268. The box 1268 includes one or more possible authoritative items that the unmapped items can be mapped to. A user can map one or more similar unmapped items shown in the box 1266 to an authoritative item shown in the box 1268. For example, a user selects unmapped items 1272, 1274 and an authoritative item 1276, and maps the items 1272, 1274 to the item 1276 by clicking on the “map” button 1270. The example user interface presents a message to the user if the mapping is successful. A user can map all the unmapped items for each code list by performing operations similar to those described above with reference to FIGS. 12A-12C.

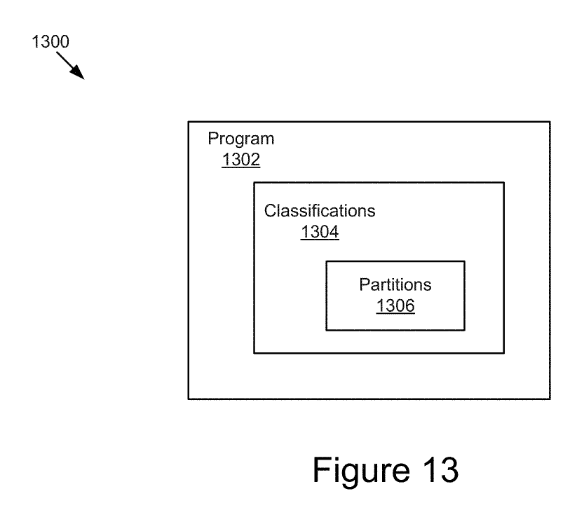

FIG. 13 is a graphic representation 1300 illustrating an example program 1302 for a practice according to some embodiments. Examples of a program 1302 include, but are not limited to, Medicare shared savings program and Performance Improvement Measurement System (PIMS) grant program, etc. Different practices may have different programs 1302. The program 1302 includes one or more classifications 1304 such as adult weight screening and follow-up. For each classification 1304, there can be one or more partitions 1306.

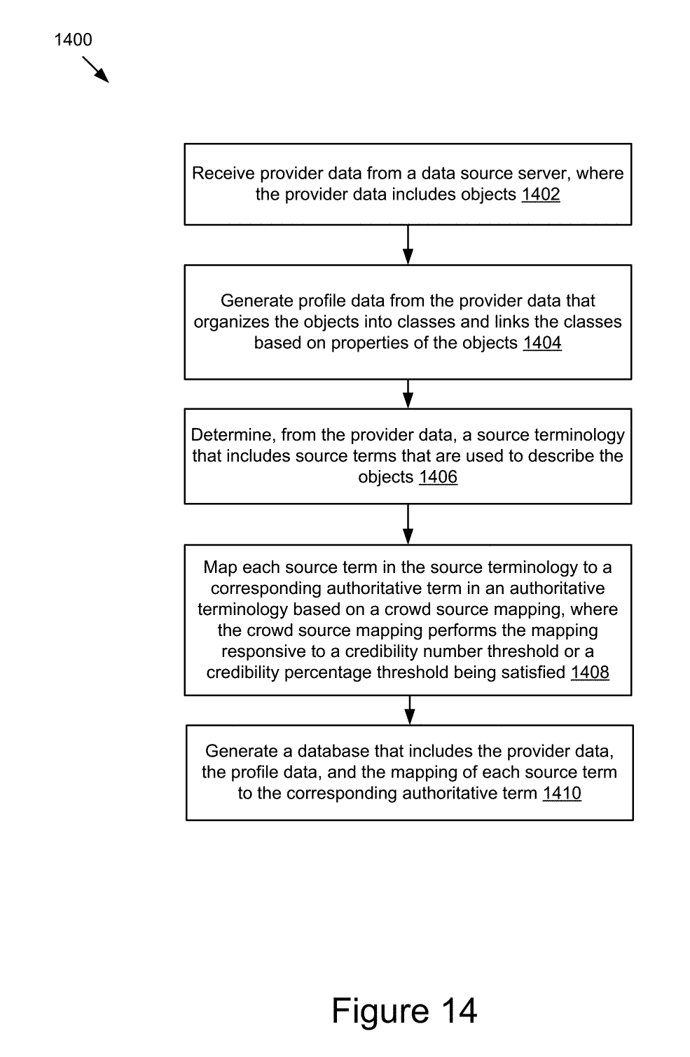

FIG. 14 is a flowchart illustrating a method 1400 for generating a database 138 according to some embodiments. The method 1400 may be performed by the data management application 103 of FIGS. 1 and 2. Provider data 139 is received 1402 from a data source server 105, where the provider data 139 includes objects. Profile data 142 is generated 1404 from the provider data 139 that organizes the objects into classes and links the classes based on properties of the objects. A source terminology is determined 1406 from the provider data 139 that includes source terms that are used to describe the objects. Each source term in the source terminology is mapped 1410 to a corresponding authoritative term in an authoritative terminology based on a crowd source mapping, where the crowd source mapping performs the mapping responsive to a credibility number threshold or a credibility percentage threshold being satisfied. A database 138 is generated 1410 that includes the provider data 139, the profile data 142, and the mapping of each source term to the corresponding authoritative term.

In the foregoing description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in some embodiments below with reference to user interfaces and particular hardware. However, the description applies to any type of computing device that can receive data and commands, and any peripheral devices providing services.

Reference in the specification to “some embodiments” or “an embodiment” means that a particular feature, structure, or characteristic described in connection with the embodiment is included in at least some embodiments. The appearances of the phrase “in some embodiments” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is generally conceived to be a self consistent sequence of steps leading to a desired result. The steps are those requiring physical manipulations of physical quantities. Usually, though not necessarily, these quantities are signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as processing or computing or calculating or determining or displaying or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, compact disc read-only memories (CD-ROMs), magnetic disks, read-only memories (ROMs), random access memories (RAMs), erasable programmable read-only memories (EPROMs), electrically erasable programmable read-only memories (EEPROMs), magnetic or optical cards, flash memories including universal serial bus (USB) keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer-implemented method of generating a database that reduces storage space and improves data retrieval time, the method comprising:
receiving provider data from a data source server, wherein the provider data includes objects;
generating profile data from the provider data that organizes the objects into classes and links the classes based on properties of the objects;
determining, from the provider data, a source terminology that includes source terms that are used to describe the objects;
mapping each source term in the source terminology to a corresponding authoritative term in an authoritative terminology based on a crowd source mapping, wherein the crowd source mapping performs the mapping responsive to a credibility number threshold or a credibility percentage threshold being satisfied; and
generating a database that includes the provider data, the profile data, and the mapping of each source term to the corresponding authoritative term.

2. The method of claim 1, further comprising:
receiving feedback from a user about the mapping; and
revising the mapping based on the feedback;
wherein the mapping and revising the mapping are based on machine learning.

3. The method of claim 1, further comprising:
receiving a query that includes search terms for data files that correspond to the search terms;
retrieving search results that correspond to the data files from the database; and
generating a report that includes the search results.

4. The method of claim 1, further comprising:
applying a classification structure to profile data by starting at a root partition and, responsive to the profile data satisfying criteria of a root class, descending to the root class, responsive to the profile data satisfying criteria of a child class, descending to the child class, and continuing to descend until the profile data arrives at a final class in the classification structure.

5. The method of claim 1, wherein:
the credibility number threshold is satisfied if a number of data source providers from a set of data source providers map the source term to a same authoritative term as the corresponding authoritative term exceeds the credibility number threshold; and
the credibility percentage threshold is satisfied if a percentage of the data source providers from the set of data source providers map the source term to the same authoritative term as the corresponding authoritative term exceeds the credibility percentage threshold.

6. The method of claim 1, further comprising:
receiving rule data describing a declarative classification rule from a client device, wherein the declarative classification rule defines one or more partitions in a classification structure.

7. The method of claim 1, wherein each object has an object class and a mood and wherein the mood indicates one of an act that has happened, a request for an act to happen, a goal, and a criterion.

8. The method of claim 1, further comprising:
storing the profile data as a graph comprising nodes, wherein each node represents one of the classes that applies to a patient.

9. The method of claim 1, further comprising:
updating the profile data to describe the objects using the authoritative terminology; and
updating the database to include updated profile data.

10. A non-transitory computer storage medium encoded with a computer program, the computer program comprising instructions that, when executed by one or more computers, cause the one or more computers to perform operations comprising:
receiving provider data from a data source server, wherein the provider data includes objects;
generating profile data from the provider data that organizes the objects into classes and links the classes based on properties of the objects;
determining, from the provider data, a source terminology that includes source terms that are used to describe the objects;
mapping each source term in the source terminology to a corresponding authoritative term in an authoritative terminology based on a crowd source mapping, wherein the crowd source mapping performs the mapping responsive to a credibility number threshold or a credibility percentage threshold being satisfied; and
generating a database that includes the provider data, the profile data, and the mapping of each source term to the corresponding authoritative term.

11. The computer storage medium of claim 10, wherein the instructions are further operable to perform operations comprising:
receiving feedback from a user about the mapping; and
revising the mapping based on the feedback;
wherein the mapping and revising the mapping are based on machine learning.

12. The computer storage medium of claim 10, wherein the instructions are further operable to perform operations comprising:
receiving a query that includes search terms for data files that correspond to the search terms;
retrieving search results that correspond to the data files from the database; and
generating a report that includes the search results.

13. The computer storage medium of claim 10, wherein the instructions are further operable to perform operations comprising:
applying a classification structure to profile data by starting at a root partition and, responsive to the profile data satisfying criteria of a root class, descending to the root class, responsive to the profile data satisfying criteria of a child class, descending to the child class, and continuing to descend until the profile data arrives at a final class in the classification structure.

14. The computer storage medium of claim 10, wherein”
the credibility number threshold is satisfied if a number of data source providers from a set of data source providers map the source term to a same authoritative term as the corresponding authoritative term exceeds the credibility number threshold; and
the credibility percentage threshold is satisfied if a percentage of the data source providers from the set of data source providers map the source term to the same authoritative term as the corresponding authoritative term exceeds the credibility percentage threshold.

15. A system comprising:
a non-transitory memory storing computer code which, when executed by a processor, causes the computer code to:
receive provider data from a data source server, wherein the provider data includes objects;
generate profile data from the provider data that organizes the objects into classes and links the classes based on properties of the objects;
determine, from the provider data, a source terminology that includes source terms that are used to describe the objects;
map each source term in the source terminology to a corresponding authoritative term in an authoritative terminology based on a crowd source mapping, wherein the crowd source mapping performs the mapping responsive to a credibility number threshold or a credibility percentage threshold being satisfied; and
generate a database that includes the provider data, the profile data, and the mapping of each source term to the corresponding authoritative term.

16. The system of claim 15, wherein the computer code is further operable to:
receive feedback from a user about the mapping; and
revise the mapping based on the feedback;
wherein the mapping and revising the mapping are based on machine learning.

17. The system of claim 15, wherein the computer code is further operable to:
receive a query that includes search terms for data files that correspond to the search terms;
retrieve search results that correspond to the data files from the database; and
generate a report that includes the search results.

18. The system of claim 15, wherein the computer code is further operable to:
apply a classification structure to profile data by starting at a root partition and, responsive to the profile data satisfying criteria of a root class, descending to the root class, responsive to the profile data satisfying criteria of a child class, descending to the child class, and continuing to descend until the profile data arrives at a final class in the classification structure.

19. The system of claim 15, wherein:
the credibility number threshold is satisfied if a number of data source providers from a set of data source providers map the source term to a same authoritative term as the corresponding authoritative term exceeds the credibility number threshold; and
the credibility percentage threshold is satisfied if a percentage of the data source providers from the set of data source providers map the source term to the same authoritative term as the corresponding authoritative term exceeds the credibility percentage threshold.

20. The system of claim 15, wherein the computer code is further operable to:
receiving rule data describing a declarative classification rule from a client device, wherein the declarative classification rule defines one or more partitions in a classification structure.
